(19) United States
(12) Patent Application Publication
(10) Pub. No.: US 2018/0309538 A1
(43) Pub. Date: Oct. 25, 2018

(54) DATA RATE SELECTION FOR WAKE-UP RADIO TRANSMISSIONS

(71) Applicant: QUALCOMM Incorporated, San Diego, CA (US)

(72) Inventors: Lochan Verma, San Diego, CA (US); Stephen Jay Shellhammer, Ramona, CA (US); Bin Tian, San Diego, CA (US)

(21) Appl. No.: 15/960,198

(22) Filed: Apr. 23, 2018

Related U.S. Application Data
(60) Provisional application No. 62/489,879, filed on Apr. 25, 2017.

(51) Int. Cl. H04L 1/00; H04W 28/22

(52) U.S. Cl. CPC H04L 1/0025; H04L 1/0009; H04L 1/0002; H04W 28/22

(57) ABSTRACT

Methods, systems, and devices for data rate adaptation to extend the range of wake-up radio transmissions sent to a wake-up radio of a station (STA). Data rate adaptation procedures may be used to select a data rate for wake-up radio transmission based on one or more identified parameters. An access point may execute one or more different types of rate adaptation procedures to select the appropriate data rate. In some examples, the access point may select a data rate of wake-up radio transmissions based on one or more messages failing to be successfully decoded. In some examples, the access point may select a data rate of wake-up radio transmissions based on a distance between the access point and the station. In some examples, the access point may select a data rate of wake-up radio transmission based on information identified during a training procedure.

### CROSS REFERENCES

The present Application for Patent claims priority to U.S. Provisional Patent Application No. 62/489,879 by Verma, et al., entitled “Data Rate Selection For Wake-Up Radio Transmissions,” filed Apr. 25, 2017, assigned to the assignee hereof.

### BACKGROUND

The following relates generally to wireless communication in a system that supports communication using a primary radio and a wake-up radio, and more specifically to data rate selection for wake-up radio transmissions.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include an access point (AP) that may communicate with one or more stations (STAs) or mobile devices (sometimes referred to as wireless devices). The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

### SUMMARY

The described techniques relate to methods, systems, devices, or apparatuses that support data rate (e.g., physical layer (PHY)) rate selection for wake-up radio transmissions. Generally, the described techniques provide for using data rate adaptation procedures, which may extend the range of wake-up radio transmissions sent to a wake-up radio of a station. In some instances, transmitting messages at lower data rates may extend the range of such messages. Messages transmitted at lower data rates, however, use more communication resources because they take more time to transmit than messages transmitted at higher data rates. Data rate adaptation procedures may be used to select a data rate for wake-up radio transmission based on one or more identified parameters. An access point may execute one or more different types of rate adaptation procedures. In some examples, the access point may select a data rate of wake-up radio transmissions based on one or more messages failing to be successfully decoded. In some examples, the access point may select a data rate of wake-up radio transmissions based on a distance between the access point and the station. In some examples, the access point may select a data rate of wake-up radio transmission based on information identified during a training procedure.

A method of wireless communication at an access point in a system that supports communication using a primary radio and a wake up radio is described. The method may include determining that a parameter associated with a first signal transmitted to a wake up radio of a station at a first data rate satisfies a threshold, selecting a second data rate less than the first data rate based at least in part on determining that the parameter satisfies the threshold, and transmitting a second signal to the wake up radio of the station at the second data rate.

An apparatus for wireless communication at an access point in a system that supports communication using a primary radio and a wake up radio is described. The apparatus may include means for determining that a parameter associated with a first signal transmitted to a wake up radio of a station at a first data rate satisfies a threshold, means for selecting a second data rate less than the first data rate based at least in part on determining that the parameter satisfies the threshold, and means for transmitting a second signal to the wake up radio of the station at the second data rate.

Another apparatus for wireless communication at an access point in a system that supports communication using a primary radio and a wake up radio is described. The apparatus may include a processor, memory in electronic communication with the processor, and instructions stored in the memory. The instructions may be operable to cause the processor to determine that a parameter associated with a first signal transmitted to a wake up radio of a station at a first data rate satisfies a threshold, select a second data rate less than the first data rate based at least in part on determining that the parameter satisfies the threshold, and transmit a second signal to the wake up radio of the station at the second data rate.

A non-transitory computer readable medium for wireless communication at an access point in a system that supports communication using a primary radio and a wake up radio is described. The non-transitory computer-readable medium may include instructions operable to cause a processor to determine that a parameter associated with a first signal transmitted to a wake up radio of a station at a first data rate satisfies a threshold, select a second data rate less than the first data rate based at least in part on determining that the parameter satisfies the threshold, and transmit a second signal to the wake up radio of the station at the second data rate.

Some examples of the method, apparatus, and non-transitory computer-readable medium described above may further include processes, features, means, or instructions for receiving an indication from the station that the station failed to decode two or more consecutive packets transmitted at the first data rate, wherein determining that the parameter satisfies the threshold may be based at least in part on receiving the indication.

Some examples of the method, apparatus, and non-transitory computer-readable medium described above may further include processes, features, means, or instructions for transmitting a beacon at the first data rate at a predetermined time based at least in part on a beacon schedule.

In some examples of the method, apparatus, and non-transitory computer-readable medium described above, the indication that the station failed to decode the two or more consecutive packets indicates that the station failed to decode two consecutive beacons transmitted at the first data rate.

Some examples of the method, apparatus, and non-transitory computer-readable medium described above may further include processes, features, means, or instructions for determining that an expected message from the station failed to be received using a primary radio of the station, wherein determining that the parameter satisfies the threshold may be based at least in part on determining that the expected message failed to be received.

Some examples of the method, apparatus, and non-transitory computer-readable medium described above may further include processes, features, means, or instructions for transmitting a traffic indication message to the wake up radio of the station at the first data rate based at least in part on identifying buffered data for the station, wherein the expected message includes a response to the traffic indication message.

In some examples of the method, apparatus, and non-transitory computer-readable medium described above, the traffic indication message may include an indication for the station to communicate with the access point using the primary radio of the station.

Some examples of the method, apparatus, and non-transitory computer-readable medium described above may further include processes, features, means, or instructions for identifying a distance between the access point and the station, wherein determining that the parameter satisfies the threshold may be based at least in part on the distance between the access point and the station.

Some examples of the method, apparatus, and non-transitory computer-readable medium described above may further include processes, features, means, or instructions for determining that the distance satisfies a distance threshold, wherein the second data rate may be selected based at least in part on the distance threshold being satisfied.

Some examples of the method, apparatus, and non-transitory computer-readable medium described above may further include processes, features, means, or instructions for initiating a fine timing measurement (FTM) procedure, wherein the distance identified may be based at least in part on the FTM procedure.

Some examples of the method, apparatus, and non-transitory computer-readable medium described above may further include processes, features, means, or instructions for identifying a received signal strength indicator (RSSI) associated with the station, wherein determining that the parameter satisfies the threshold may be based at least in part on the RSSI.

Some examples of the method, apparatus, and non-transitory computer-readable medium described above may further include processes, features, means, or instructions for transmitting a first training message at the first data rate to the wake-up radio of the station. Some examples of the method, apparatus, and non-transitory computer-readable medium described above may further include processes, features, means, or instructions for receiving a training response message from a primary radio of the station based at least in part on the first training message, wherein determining that the parameter satisfies the threshold may be based at least in part on the training response message.

Some examples of the method, apparatus, and non-transitory computer-readable medium described above may further include processes, features, means, or instructions for transmitting a second training message at the second data rate to the wake-up radio of the station, wherein the training response message may be based at least in part on the first training message and the second training message.

In some examples of the method, apparatus, and non-transitory computer-readable medium described above, the first training message may be transmitted periodically based at least in part on a training schedule.

Some examples of the method, apparatus, and non-transitory computer-readable medium described above may further include processes, features, means, or instructions for identifying a second parameter based on a second set of conditions different from a first set of conditions used to identify the parameter, wherein selecting the second data rate may be based at least in part on the second parameter and the parameter.

In some examples of the method, apparatus, and non-transitory computer-readable medium described above, each of the first signal and the second signal transmitted to the wake up radio indicates at which data rate each of the first signal and the second signal was transmitted.

A method of wireless communication at an access point in a system that supports communication using a primary radio and a wake up radio is described. The method may include determining that a parameter associated with a first signal transmitted by an access point to the wake up radio of the station at a first data rate satisfies a threshold, transmitting a message to the access point using the primary radio of the station based at least in part on determining that the parameter satisfies the threshold, and receiving a second signal at a second data rate less than the first data rate using the wake up radio of the station based at least in part on transmitting the message.

An apparatus for wireless communication at a station in a system that supports communication using a primary radio and a wake up radio is described. The apparatus may include means for determining that a parameter associated with a first signal transmitted by an access point to the wake up radio of the station at a first data rate satisfies a threshold, means for transmitting a message to the access point using the primary radio of the station based at least in part on determining that the parameter satisfies the threshold, and means for receiving a second signal at a second data rate less than the first data rate using the wake up radio of the station based at least in part on transmitting the message.

Another apparatus for wireless communication at a station in a system that supports communication using a primary radio and a wake up radio is described. The apparatus may include a processor, memory in electronic communication with the processor, and instructions stored in the memory. The instructions may be operable to cause the processor to determine that a parameter associated with a first signal transmitted by an access point to the wake up radio of the station at a first data rate satisfies a threshold, transmit a message to the access point using the primary radio of the station based at least in part on determining that the parameter satisfies the threshold, and receive a second signal at a second data rate less than the first data rate using the wake up radio of the station based at least in part on transmitting the message.

A non-transitory computer readable medium for wireless communication at a station in a system that supports communication using a primary radio and a wake up radio is described. The non-transitory computer-readable medium may include instructions operable to cause a processor to determine that a parameter associated with a first signal transmitted by an access point to the wake up radio of the station at a first data rate satisfies a threshold, transmit a message to the access point using the primary radio of the station based at least in part on determining that the parameter satisfies the threshold, and receive a second signal at a second data rate less than the first data rate using the wake up radio of the station based at least in part on transmitting the message.

Some examples of the method, apparatus, and non-transitory computer-readable medium described above may further include processes, features, means, or instructions for determining that two or more consecutive packets transmitted at the first data rate to the wake up radio of the station failed to be decoded, wherein determining that the parameter satisfies the threshold may be based at least in part on failing to decode the two or more consecutive packets.

In some examples of the method, apparatus, and non-transitory computer-readable medium described above, the message indicates that the station failed to decode two consecutive beacons transmitted at the first data rate to the wake up radio of the station.

In some examples of the method, apparatus, and non-transitory computer-readable medium described above, the two or more consecutive packets may be beacons transmitted according to a beacon schedule.

Some examples of the method, apparatus, and non-transitory computer-readable medium described above may further include processes, features, means, or instructions for receiving a request initiating a fine timing measurement (FTM) procedure, wherein determining that the parameter satisfies the threshold may be based at least in part on the FTM procedure.

Some examples of the method, apparatus, and non-transitory computer-readable medium described above may further include processes, features, means, or instructions for receiving a first training message at the first data rate using the wake-up radio of the station. Some examples of the method, apparatus, and non-transitory computer-readable medium described above may further include processes, features, means, or instructions for transmitting a training response message using the primary radio of the station based at least in part on the first training message, wherein determining that the parameter satisfies the threshold may be based at least in part on the training response message.

Some examples of the method, apparatus, and non-transitory computer-readable medium described above may further include processes, features, means, or instructions for receiving a second training message at the second data rate using the wake-up radio, wherein the training response message may be based at least in part on the first training message and the second training message.

### BRIEF DESCRIPTION OF THE DRAWINGS

FIG. 1 illustrates an example of a system for wireless communication at an access point in a system that supports communication using a primary radio and a wake-up radio that supports data rate selection for wake-up radio transmissions in accordance with aspects of the present disclosure.

FIG. 2 illustrates an example of a wireless communication system that supports data rate selection for wake-up radio transmissions in accordance with aspects of the present disclosure.

FIG. 3 illustrates an example of a communication scheme that supports data rate selection for wake-up radio transmissions in accordance with aspects of the present disclosure.

FIG. 4 illustrates an example of a communication scheme that supports data rate selection for wake-up radio transmissions in accordance with aspects of the present disclosure.

FIG. 5 illustrates an example of a communication scheme that supports data rate selection for wake-up radio transmissions in accordance with aspects of the present disclosure.

FIG. 6 illustrates an example of a communication scheme that supports data rate selection for wake-up radio transmissions in accordance with aspects of the present disclosure.

FIG. 7 illustrates an example of a communication scheme that supports data rate selection for wake-up radio transmissions in accordance with aspects of the present disclosure.

FIGS. 8 through 10 show block diagrams of a device that supports data rate selection for wake-up radio transmissions in accordance with aspects of the present disclosure.

FIG. 11 illustrates a block diagram of a system including an access point that supports data rate selection for wake-up radio transmissions in accordance with aspects of the present disclosure.

FIGS. 12 through 14 show block diagrams of a device that supports data rate selection for wake-up radio transmissions in accordance with aspects of the present disclosure.

FIG. 15 illustrates a block diagram of a system including a wireless device that supports data rate selection for wake-up radio transmissions in accordance with aspects of the present disclosure.

FIGS. 16 through 21 illustrate methods for data rate selection for wake-up radio transmissions in accordance with aspects of the present disclosure.

### DETAILED DESCRIPTION

A data rate may be dynamically adapted to accommodate wireless devices that employ certain power saving techniques. For example, to conserve power, some battery-powered stations (STAs) or wireless devices may enter a sleep mode (e.g., low-power mode) based on being inactive for a certain time period. During the sleep mode, the station may deactivate portions of a primary radio and activate a wake-up radio to periodically listen for signals or beacons transmitted from an access point, including traffic indication messages. A primary radio may be also referred to as a primary connectivity radio (PCR) or a main radio. The wake-up radio may be configured to use less power than a primary radio of the station. In some examples, the range of the wake-up radio may not be as large as the range of the primary radio. As such, the wake-up radio of the station may be out-of-range of some messages that would be in-range of the primary radio of the station.

Techniques are described herein for using data rate adaptation procedures, which may extend the range of wake-up radio transmissions sent to a wake-up radio of a station. In some instances, transmitting messages at lower data rates may extend the range of such messages. Messages transmitted at lower data rates may, however, use more communication resources because they take more time to transmit than messages transmitted at higher data rates. Data rate adaptation procedures may be used to select a data rate for wake-up radio transmission based on one or more identified parameters. An access point may execute one or more different types of rate adaptation procedures to select the appropriate data rate. In some examples, the access point may select a data rate of wake-up radio transmissions based on one or more messages failing to be successfully decoded. In some examples, the access point may select a data rate of wake-up radio transmissions based on a distance between the access point and the station. In some examples, the access point may select a data rate of wake-up radio transmission based on information identified during a training procedure.

Aspects of the disclosure introduced above are described below in the context of a wireless communications system. Aspects of the disclosure are illustrated by and described with reference to communication scheme diagrams. Aspects of the disclosure are further illustrated by and described with reference to apparatus diagrams, system diagrams, and flowcharts that relate to data rate selection for wake-up radio transmissions

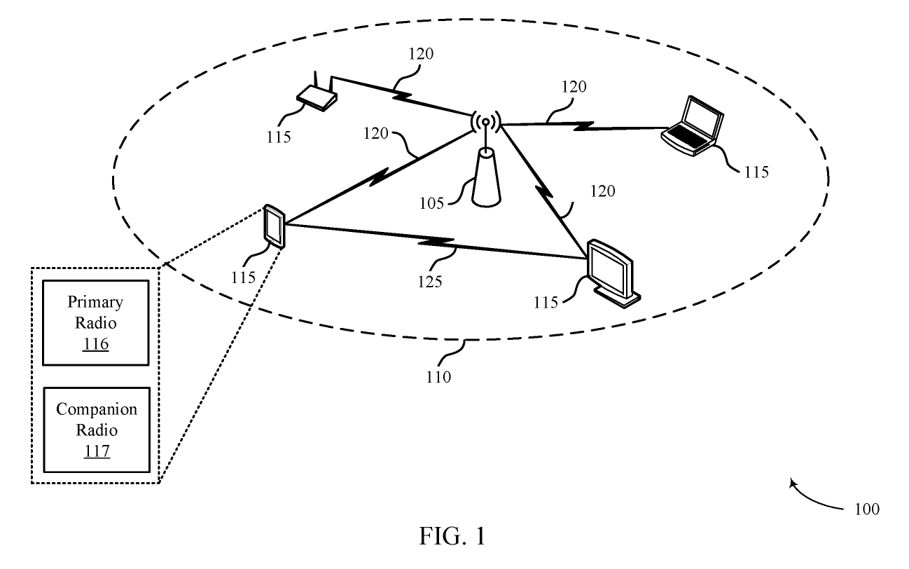

FIG. 1 illustrates a wireless local area network (WLAN) 100 (also known as a Wi-Fi network) configured in accordance with various aspects of the present disclosure. The WLAN 100 may include an AP 105 and multiple associated wireless devices 115 (sometimes referred to as STAs), which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

In some instances, a wireless device 115 may use a companion radio (e.g., wake-up radio) to conserve power during a low-power mode. Because many wireless devices 115 may be battery operated, users frequently desire that the power consumption of the wireless device 115 to be reduced to length out the battery life of the wireless device 115. During a low-power mode, to conserve power, a wireless device 115 may deactivate its radios and cease continuously listening to communication links. To ensure that the wireless device 115 does not miss communications, the wireless device 115 may periodically activate its radio(s) and listen to determine whether data is waiting to be transferred to the wireless device 115. To conserve even more power, some wireless device 115 may be equipped with a companion radio 117 in addition to its primary radio 116. In such examples, the companion radio 117 may be configured to use less power than a primary radio 116. Techniques are described herein to alter the data rate of the companion radio 117 to improve performance of the wireless device 115 during low-power mode.

Although not shown in FIG. 1, a wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 120 may include Wi-Fi Direct connections, Wi-Fi Tunneled Direct Link Setup (TDLS) links, and other group connections. wireless devices 115 and APs 105 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a wireless device 115 (or an AP 105) may be detectable by a central AP 105, but not by other wireless devices 115 in the coverage area 110 of the central AP 105. For example, one wireless device 115 may be at one end of the coverage area 110 of the central AP 105 while another wireless device 115 may be at the other end. Thus, both wireless devices 115 may communicate with the AP 105, but may not receive the transmissions of the other. This may result in colliding transmissions for the two wireless devices 115 in a contention based environment (e.g., CSMA/CA) because the wireless devices 115 may not refrain from transmitting on top of each other. A wireless device 115 whose transmissions are not identifiable, but that is within the same coverage area 110 may be known as a hidden node. CSMA/CA may be supplemented by the exchange of a request-to-send (RTS) packet transmitted by a sending wireless device 115 (or AP 105) and a clear-to-send (CTS) packet transmitted by the receiving wireless device 115 (or AP 105). This may alert other devices within range of the sender and receiver not to transmit for the duration of the primary transmission. Thus, RTS/CTS may help mitigate a hidden node problem.

In some cases, a wireless device 115 may enter a low-power mode or a sleep mode to conserve power. During the low-power mode, the device may wake periodically to listen for a delivery traffic indication message (DTIM). As part of listening, the wireless device 115 may activate certain radio components used for DTIM reception. In some cases, the wireless device 115 may wake-up early to account for possible timing asynchronization with the AP 105. If the DTIM is not received at the expected time, the wireless device 115 may wait for a beacon miss timer to expire. If a DTIM (or a standard traffic indication message (TIM)) is received, the wireless device 115 may then wait for the indicated transmission until a content after beacon (CAB) timer expires. If either timer expires, the wireless device 115 may re-enter sleep mode and wait for the next anticipated DTIM/beacon. In some cases, activating and deactivating a radio to receive DTIMs may drain the battery of a power limited device (such as battery powered device that is part of an internet of things (JOT) network).

A wireless device 115 may include a primary radio 116 and a low-power companion radio 117 for communication. The primary radio 116 may be used during active modes or for high-data throughput applications. The low-power companion radio 117 may be used during low-power modes or for low-throughput applications. In some examples, the primary radio 116 may be configured for two-way communication and the companion radio 117 may be configured for reception only. In some examples, the low-power companion radio 117 may be a wake-up receiver.

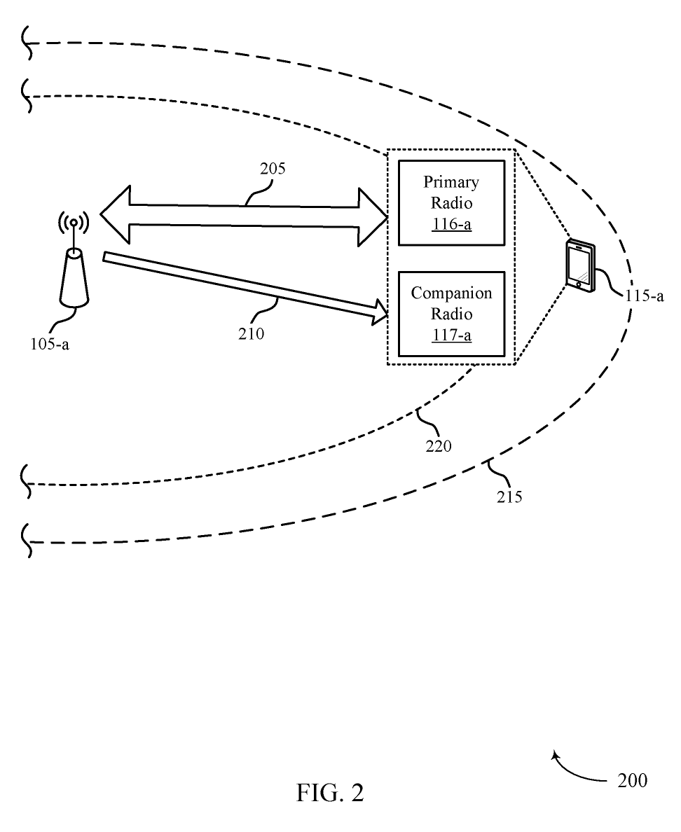

FIG. 2 illustrates an example of a wireless communication system 200 that supports data rate selection for wake-up radio transmissions in accordance with various aspects of the present disclosure. Messages communicated with a companion radio may be communicated using different data rates. The different data rates may be configured such that other parameters of the companion radio communications match similar characteristics of a primary radio (e.g., transmission range).

The wireless communication system 200 may include a wireless device 115-a and an AP 105-a. The wireless device 115-a may include a primary radio 116-a and a low-power companion radio 117-a. A first communication link 205 may be established between AP 105-a and the primary radio 116-a of the wireless device 115-a. In some examples, the first communication link 205 may be configured to provide two-way communication between the wireless device 115-a and the AP 105-a. In addition, the first communication link 205 may be configured to provide a high-throughput of data. A second communication link 210 may be established between the AP 105-a and the low-power companion radio 117-a of the wireless device 115-a. In some examples, the second communication link 210 may be configured to provide one-way communication for data transmitted by the AP 105-aa to the wireless device 115-a. The second communication link 210 and/or the companion radio 117-a may be configured to use less power than the first communication link 205 and/or the primary radio 116-a. The communication links 205, 210 may be examples of wireless links 120 described with reference to FIG. 1.

The wireless devices 115-a may be designed to allow a user to communicate (e.g., send and/or receive) data with various networks and entities. In some circumstances, the wireless device 115-a may be instructed to download a large amount of data. The primary radio 116 may be configured to provide a relatively high throughput of data to meet the needs of a user of the wireless device 115-a. Radios configured to provide high-data-throughput may require more power than other types of radios. Because the wireless device 115-a may be battery-powered in some instances, reducing power consumption may extend a battery-life of the wireless device 115-a.

In some circumstances, to conserve power, the wireless device 115-a may operate in a low-power mode (e.g., the wireless device 115-a may be considered in active). During a low-power mode, the wireless device 115-a may deactivate the primary radio 116-a (e.g., the high-through put radio) to conserve power. The user, however, may still desire to receive data (e.g., a text message or an email) even when the wireless device 115-a is in a low-power mode. As such, the companion radio 117-a may be configured to receive communications from the AP 105-a, while the wireless device 115-a is in a low-power mode. The companion radio 117-a may be an example of a wake-up radio.

During a low-power mode of the wireless device 115-a, the AP 105-a and the wireless device 115-a may establish a communication schedule. The communication schedule specifies times at which the AP 105-a should transmit beacons or traffic indication messages to the wireless device 115-a. Based on a synchronized clock, the wireless device 115-a may wake-up at those same intervals to listen for the beacons or the traffic indication messages. Rather than activating the primary radio 116-a, the wireless device 115-a may activate the companion radio 117-a to conserve power.

While the wireless device 115-a is in a low-power mode, the AP 105-a may monitor incoming traffic to determine whether any data needs to be transmitted to the wireless device 115-a. If data is addressed to the wireless device 115-a, the AP 105-a may buffer the data and may alert the wireless device 115-a about the buffered data using a scheduled beacon or traffic indication message. During a low-power mode, the AP 105-a may initiate communications with the wireless device 115-a by transmitting a wake-up message including a device specific sequence using the second communication link 210. Upon receiving a wake-up message, the wireless device 115-a may activate its primary radio 116-a to communicate with the AP 105-a.

Once the wireless device 115-a has activated its primary radio 116-a, data may be exchanged via the first communication link 205, which may be capable of a higher throughput of data than the second communication link 210. In one mode, the low power receiver (e.g., the companion radio 117-a) may listen for a wake-up message and wake-up a primary radio, which can be placed into its lowest power mode. In another mode, the low power receiver may be used independently of a primary radio for low power communications (for example, the low power receiver may be used with an internet of things (IoT) device).

The characteristics of the companion radio 117-a may be different than characteristics of the primary radio 116-a. In some cases, this may be due to the different power consumption requirements and other communication requirements associated with each radio. For example, the primary radio 116-a may have a coverage area 215 that is larger than a coverage area 220 of the companion radio 117-a.

If the coverage area 220 is smaller than the coverage area 215, the wireless device 115-a may fail to receive data from the AP 105-a intended for the wireless device 115-a when in a low-power mode. For example, when the wireless device 115-a is in a low-power mode, upon identifying buffered data waiting to be transmitted to the wireless device 115-a, the AP 105-a may transmit a traffic indication message (e.g., DTIM) to the companion radio 117-a. If the coverage area 220 is less than coverage area 215, the wireless device 115-a may fail to receive the traffic indication message. Because the wireless device 115-a did not receive the traffic indication message, the wireless device will not activate its primary radio 116-a to receive the data, even though the wireless device 115-a is within the coverage area 215 of the primary radio 116-a.

To address these issues and other issues that may arise between mismatched characteristics of radios, the wireless communication system 200 may be configured to adapt a data rate of messages associated with the companion radio 117-a. A correlation exists between a data rate at which a message is transmitted and the broadcast range of that message. For example, the slower the data rate the longer the range of the message. A slower data rate, however, yield a longer transmission time and therefore uses more wireless resources. As such, techniques are disclosed herein for matching the data rate of companion radio transmissions to network conditions to as to balance competing network requirements (e.g., range and transmission time).

Rate adaptation in some wireless contexts may already be used to achieve longer range. For example, primary radios 116-a that use a first radio access technology (e.g., 802.11a, 802.11b, or 802.11g) may define a variety of PHY data rates to achieve longer ranges. Each radio access technology (RAT), however, may not define the same PHY data rates. For example, 802.11a and the 802.11g may define a lowest PHY rate of 6 Mb/s and 802.11b may define a lowest PHY rate of 1 Mb/s. In some examples, the data rate adaptation procedures discussed herein may be implemented by a device communicating using a shared frequency spectrum band (e.g., unlicensed frequency spectrum band). In some examples, the data rate adaption procedures discussed herein may be implemented by a device communicating using a managed frequency spectrum band (e.g., licensed frequency spectrum band).

So that the companion radio 117-a can work with a variety of RATs, the companion radio 117-a may define multiple PHY data rates for communications associated with the companion radio 117-a. For example, the defined PHY data rates may include two PHY data rates at 250 Kb/s and 62.5 Kb/s for companion radio transmissions. In some cases, the companion radio 117-a may define a first data rate that corresponds to a first RAT (e.g., 802.11a or 802.11g) and a second data rate that corresponds to a second RAT (e.g., 802.11b). In some cases, data rates associated with the companion radio 117-a may be less than the data rates associated with the primary radio 116-a. For example, if the data rates for the primary radio 116-a are measured in Mb/s, the data rates for the companion radio may be measured in Kb/s. The companion radio 117-a may define any number of data rates including, for example, two data rates, three data rates, four data rates, five data rates, etc.

Techniques are described herein for selecting a data rate from the plurality of available data rates for companion radio transmissions based on the network conditions. In some instances, the plurality of available data rates may be pre-defined and known to both the AP 105-a and the wireless device 115-a. For example, a standard may specify the available data rates for companion radio transmissions. In such examples, each entity in a network may store the values of the available data rates. In other instances, the data rate of companion radio transmissions may be determined dynamically. For example, the AP 105-a may determine a data rate for companion radio transmissions (e.g., beacons, traffic indication messages, etc.) based on network conditions. The AP 105-a may include an indication of the data rate in each companion radio transmission. In such examples, the wireless device 115-a may determine the data rate of companion radio transmission based on the indication. In other examples, the AP 105-a may transmit a separate control message (via either the primary radio 116-a or the companion radio 117-a) to the wireless device 115-a indicating the selected data rate for companion radio transmissions. In yet other instances, a combination of these examples may be used. For example, the AP 105-a may determine a data rate before the wireless device 115-a enters a low-power mode and during the low-power mode the AP 105-a may select a new data rate based on changing network conditions. The first data rate and the new data rate may be communicated using a variety of different methods similar to those discussed above.

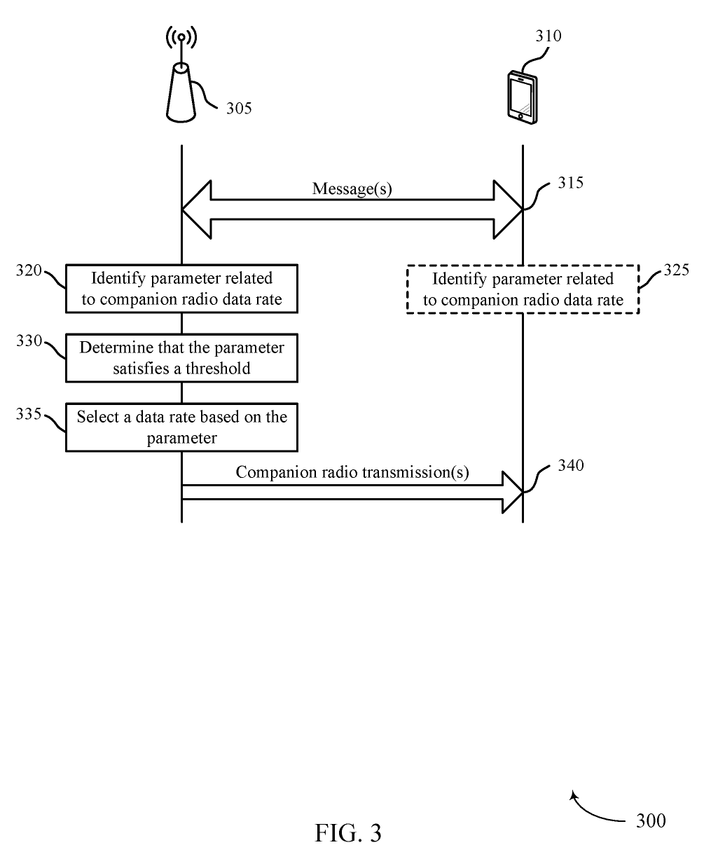

FIG. 3 illustrates an example of a communication scheme 300 that supports data rate selection for wake-up radio transmissions in accordance with various aspects of the present disclosure. In some examples, the communication scheme 300 may implement aspects of wireless communication system 100. The communication scheme 300 illustrates how an AP 305 and a wireless device 310 may perform data rate selection for companion radio transmissions. The AP 305 may be an example of the APs 105 described with reference to FIGS. 1-2. The wireless device 310 may be an example of the wireless devices 115 described with reference to FIGS. 1-2.

As part of the communication scheme 300, the AP 305 and the wireless device 310 may exchange one or more messages 315. The messages 315 may be communicated using a primary radio or a companion radio (e.g., wake-up radio). In some cases, the messages 315 may be examples of data messages, control messages, beacons, traffic indication messages, delivery traffic indication messages, training messages, fine timing measurement messages, or combinations thereof.

At block 320, the AP 305 may identify a parameter related to the companion radio data rate based at least in part on the messages 315 (or lack thereof). For example, the AP 305 may identify that certain messages were not received by the wireless device 310. In other examples, the AP 305 may identify a distance between a location of the AP 305 and a location of the wireless device 310. In other examples, the AP 305 may identify signal characteristics of the messages 315 that have been exchanged. In some examples, a parameter may refer to any information that may be used to select a data rate for companion radio transmissions. For example, the parameter may be based on receiving certain messages, failing to receive certain messages, information included in messages, training data, training messages, channel metrics (e.g., received signal strength indicator (RSSI)), information derived from other procedures (e.g., distance), time-based parameters, or combinations thereof. The nature of the parameter identified by the AP 305 may change based on the specific procedures being executed to perform data rate adaptation for companion radio transmissions. In some examples, the AP 305 may identify multiple parameters before selecting a data rate for companion radio transmissions. For example, the AP 305 may use a combination of multiple rate adaptation procedures to select the data rate for companion radio transmissions. As such, the AP 305 may identify different parameters related to the various rate adaptation procedures being executed.

At block 325, in some instances, the wireless device 310 may identify a parameter related to the companion radio data rate. In such instances, the wireless device 310 may communicate the identified parameter to the AP 305 and the AP 305 may select the data rate. For example, the wireless device 310 may identify that it has failed to receive one or more expected companion radio messages from the AP 305. In such an example, the wireless device 310 may determine that a data rate for companion radio transmission should be reduced to improve the likelihood that the transmissions will be successfully received. In other examples, the wireless device 310 may measure one or more signal characteristics of the messages 315 and reports those measured characteristics to the AP 305 to be used for selecting the data rate for companion radio transmissions. Examples of signal characteristics measured based on the messages 315 may include signal-to-noise ratio (SNR), RSSI, signal power, other signal quality indicators, or combinations thereof

At block 330, the AP 305 may determine that the parameter satisfies a threshold. If the parameter satisfies the threshold, the AP 305 may determine that the data rate of companion radio transmissions should be adjusted. The threshold may vary based on the rate adaptation procedure(s) being used, the RATs being used, the number of available data rates, the specific values of the available rates, or combinations thereof. For example, the threshold may include a number of expected messages that failed to be successfully decoded. In such examples, if a certain number of expected messages are not decoded or an expected message is not decoded in a time duration, the AP 305 may determine that the threshold is satisfied. The threshold may be predetermined, in some examples. In other examples, the threshold may be dynamically set by the AP 305 based on network conditions.

At block 335, the AP 305 may select a data rate based on the identified parameter. The data rate may refer to the how many bits of data are transmitted during a fixed time interval. For example, a data rate may refer to the amount of bits wirelessly transmitted over the air during a second (e.g., Megabits per second or kilobits per second). In some cases, the AP 305 may select the data rate from a list of known data rates. For example, the available data rates for companion radio transmissions may be indexed and known by each entity in a network. As such, the AP 305 may select one of the indexed data rates stored in memory based on the parameter. In other cases, the AP 305 may dynamically determine a data rate based on the identified parameter. In such cases, the AP 305 may simply select a data rate based on a number of factors such as the identified parameter, network conditions, reception of expected messages (or lack thereof), the RAT being implemented, the lowest data rate available for corresponding primary radio transmission, or combinations thereof.

Once the data rate is selected, the AP 305 may configure its companion radio transmissions 340 to use the selected data rate. In the event that the wireless device 310 enters a low-power mode, the AP 305 may transmit companion radio transmissions 340 to the wireless device 310 at the selected data rate. In some examples, the data rate for companion radio transmission may be altered while the wireless device 310 is in the low-power mode based on identified parameters, network conditions, other factors, or combinations thereof. Companion radio transmissions may refer to messages communicated using a companion radio (e.g., companion radio 117). Such companion radio transmission may be examples of wake-up radio messages transmitted from an AP 305 to a wireless device 310 while the wireless device 310 is in a low-power mode. Companion radio transmissions may include beacons, traffic indication messages or maps, delivery traffic indication messages or maps, or combinations thereof. In some examples, companion radio transmissions may communicate an amount of time between beacon transmissions, information for the wireless device 310 to sync its clock with the AP 305, a service set identifier (SSID), information related to the data rates supported by the particular WLAN, information about specific signaling methods, information that buffered data at the AP 305 is waiting to be transmitted to the wireless device 310, or combinations thereof. In some examples, the messages 315, the companion radio transmission 340, primary radio transmission, other data that is transmitted, or combinations thereof may be referred to as packets.

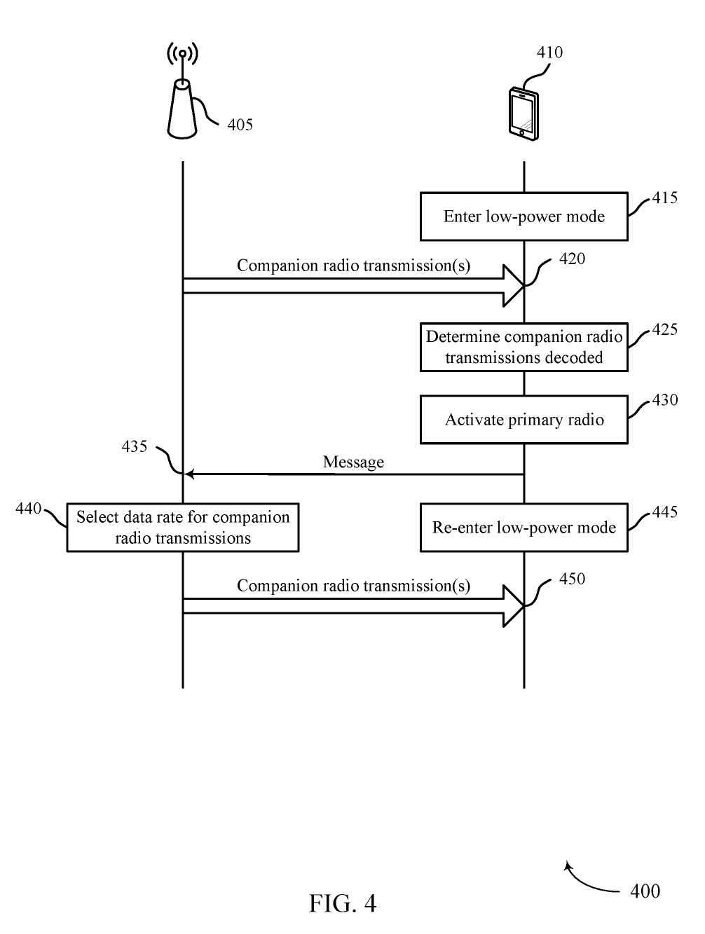

FIG. 4 illustrates an example of a communication scheme 400 that supports data rate selection for wake-up radio transmissions in accordance with various aspects of the present disclosure. In some examples, the communication scheme 400 may implement aspects of wireless communication system 100. The communication scheme 400 illustrates how an AP 405 and a wireless device 410 may perform data rate selection for companion radio transmissions. The AP 405 may be an example of the APs 105, 105-a, and 305 described with reference to FIGS. 1-3. The wireless device 410 may be an example of the wireless devices 115, 115-a, and 310 described with reference to FIGS. 1-3.

The communication scheme 400 illustrates an example of a station-assisted companion radio data rate adaptation procedure. In the data rate adaptation procedure illustrated by the communication scheme 400, the wireless device 410 may provide feedback to the AP 405 using its primary radio about companion radio transmissions. The AP 405 may use the feedback received from the wireless device 410 to select a data rate for future companion radio transmissions.

At block 415, the wireless device 410 may enter a low-power mode (e.g., a sleep mode). During the low-power mode, the wireless device 410 may deactivate or reduce the activity of a number of components, including its primary radio. The wireless device 410 may determine which components to deactivate based on a type of low-power mode being entered. In some cases, entering the low-power mode may also include activating some components such as a companion radio (e.g., wake-up radio). In some examples, the wireless device 410 may coordinate entering the low-power mode with the AP 405. For example, the wireless device 410 may transmit a message to the AP 405 indicating that it is entering the low-power mode. In some examples, the AP 405 may transmit interval information or other information related to the regular transmission of beacons or other companion radio transmission during the low-power mode. In some examples, a low-power mode may be an example of a connected standby mode.

In response to entering the low-power mode, the AP 405 may transmit companion radio transmissions 420 to the companion radio of the wireless device 410. The companion radio transmissions 420 may be examples of beacons transmitted at regular time intervals or traffic indication messages. The companion radio transmissions 420 may be examples of the companion radio transmission 340 described with reference to FIG. 3.

The companion radio transmissions 420 may be transmitted at regular intervals based on a transmission schedule (e.g., beacon schedule). The transmission schedule may be configured to coordinate the actions of the AP 405 and the wireless device 410 during a low-power mode of the wireless device 410. At time intervals specified in the transmission schedule, the wireless device 410 may power-up its companion radio to listen for messages transmitted by the AP 405. These messages may be companion radio transmissions and sync the clocks of the AP 405 and the wireless device 410 and/or inform the wireless device 410 that buffered data is waiting at the AP 405 to be transmitted to the wireless device 410.

The AP 405 may be configured to transmit the companion radio transmission 420 at a plurality of different data rates. For example, the AP 405 may be configured to transmit the companion radio transmissions 420 using either a first data rate or a second data rate less than the first data rate. In other examples, the AP 405 may be configured to transmit the companion radio transmissions 420 using any number of different data rates, such as two, three, four, five, six, seven, etc.

At block 425, the wireless device 410 may determine whether the companion radio transmissions 420 were successfully decoded. After successfully decoding a companion radio transmission 420, the wireless device 410 may initiate one or more procedures indicated by the companion radio transmission 420. For example, if the companion radio transmission 420 indicates that the AP 405 has buffered data, the wireless device 410 may activate its primary radio (at block 430) to receive the buffered data.

In some circumstances, the wireless device 410 may fail to successfully decode a companion radio transmission 420 during an expected time interval. A failure to decode or receive a companion radio transmission 420 may occur for a number of reasons. One reason such a failure may occur is because the wireless device 410 is outside the coverage area of the companion radio (see, e.g., coverage area mismatches illustrated in FIG. 2). The wireless device 410 may also track the number of expected transmission that were not successfully decoded or received during a particular time frame and/or the number of expected transmission that were successfully decoded or received during the particular time frame.

Upon determining this information, at block 430, the wireless device 410 may activate its primary radio and may transmit a message 435 to the AP 405 using the primary radio. The message 435 may indicate information related to the success or failure of the wireless device 410 in decoding or receiving expected companion radio transmissions. In some examples, the message 435 may indicate the number of failed companion radio transmission during a time frame, the number of successful companion radio transmission during a time frame, that a certain number (e.g., two, three, four, five) of consecutive companion radio transmissions failed to be decoded, that a certain number (e.g., two, three, four, five) of consecutive companion radio transmissions were successfully decoded, or combinations thereof. In some examples, the message 435 may be transmitted through a management frame or the like.

At block 440, the AP 405 may select the data rate for future companion radio transmissions based on the message 435. In some examples, the AP 405 may determine the data rate of future companion radio transmissions 420 based on the receipt of the message 435. In some examples, the AP 405 may determine the data rate of future companion radio transmissions based on information included in the message 435.

The AP 405 may identify a parameter and/or determine whether the parameter satisfies a threshold based on the message 435. In the communication scheme 400, the identified parameter may include a number of companion radio transmissions that failed to be successfully decoded or received by the wireless device 410. In the communication scheme 400, the threshold related to the parameter may include an acceptable number of failed companion radio transmissions. In some examples, the wireless device 410 may identify the parameter and/or determine whether the parameter satisfies the threshold. In such examples, the message 435 may include an indication that data rate of future companion radio communications should be adjusted (e.g., either up or down).

In some cases, available data rates for companion radio transmission may be indexed. Upon determining that the data rate should be adjusted (either increased or decreased), the AP 405 may simply increment or decrement the data rate index to identify what the new data rate should be. For example, if the AP 405 determines that the data rate for companion radio transmissions should be decreased, the AP 405 may decrement the data rate index and select the data rate at the new data rate index value. For example, if the AP 405 determines that the data rate for companion radio transmissions should be increased, the AP 405 may increment the data rate index and select the data rate at the new data rate index value.

In some examples, as part of selecting the data rate, the AP 405 may determine that the number of expected messages that failed to be decoded or received satisfies (e.g., is greater than) a threshold. For example, the threshold may be set at two consecutive missed transmissions. In such examples, if the wireless device 410 determines that two consecutive transmissions failed to be decoded or received, the wireless device 410 may transmit a message 435 to the AP 405 indicating that one or more consecutive companion radio transmissions failed to be decoded or received by the wireless device 410. In some examples, the AP 405 may use the information to reduce the data rate of future companion radio transmissions.

In other examples, the wireless device 410 may determine that a number of successfully decoded companion radio transmissions 420 exceeds a different threshold. In such examples, if the wireless device 410 determines that a certain number of consecutive transmissions have been successfully decoded or received, the wireless device 410 may transmit the message 435 to the AP 405 indicating that one or more consecutive companion radio transmissions were successfully decoded or received by the wireless device 410. In some examples, the AP 405 may use the information to increase the data rate of future companion radio transmissions.

In some examples, the information about failed and/or successfully decoded companion radio transmissions may be compared to different thresholds by the AP 405. For example, the message 435 may include time-stamped data indicating when a companion radio transmission 420 failed to be successfully decoded. If the next successfully decoded companion radio transmission fails to occur within a time threshold, the AP 405 may determine that the data rate of future companion radio transmissions should be reduced. In some examples, the AP 405 may use similar methods to determine whether the data rate of future companion radio transmissions should be increased. At block 440, the AP 405 may select the data rate for future companion radio transmissions based on the message 435.

After transmitting the message 435 using the primary radio, at block 445, the wireless device 410 may re-enter low-power mode. In some examples, re-entering the low-power mode may include deactivating or reducing power to the primary radio. In some examples, re-entering the low-power mode may be based on information exchanged when entering the low-power mode at block 415. In some examples, upon re-entering low-power mode, the wireless device 410 may use the transmission schedule already established at block 415.

Upon selecting the data rate for future companion radio transmissions at block 440, the AP 405 may transmit companion radio transmissions 450 to the companion radio of the wireless device 410 using the selected data rate. In some examples, the companion radio transmissions 450 may use a different data rate than the companion radio transmissions 420. The selected data rate may be adjusted up or down based on what conditions existed. In some examples, the selected data rate is the same as the former data rate. The AP 405 may transmit the companion radio transmissions 450 based on the transmission schedule previously determined.

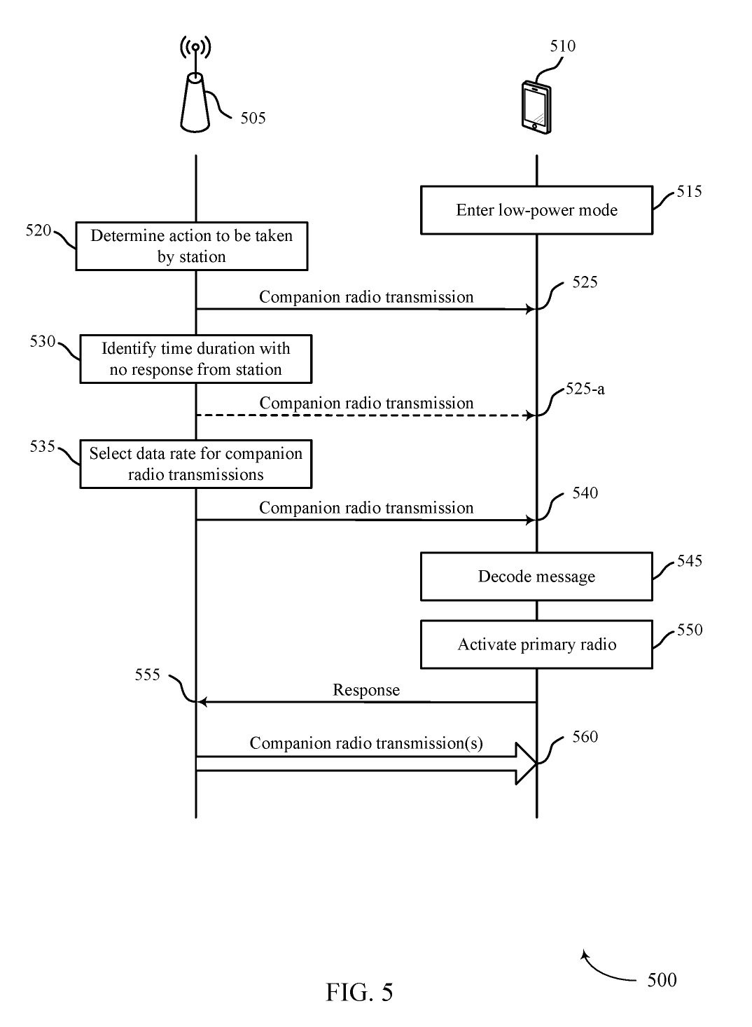

FIG. 5 illustrates an example of a communication scheme 500 that supports data rate selection for wake-up radio transmissions in accordance with various aspects of the present disclosure. In some examples, communication scheme 500 may implement aspects of wireless communication system 100. The communication scheme 500 illustrates how an AP 505 and a wireless device 510 may perform data rate selection for companion radio transmissions. The AP 505 may be an example of the APs 105, 105-a, 305, and 405 described with reference to FIGS. 1-4. The wireless device 510 may be an example of the wireless devices 115, 115-a, 310, and 410 described with reference to FIGS. 1-4.

The communication scheme 500 illustrates an example of an AP-based companion radio data rate adaptation procedure. In the data rate adaptation procedure illustrated by the communication scheme 500, the AP 505 may adjust or select data rates for future companion radio transmissions based on whether expected messages were successfully decoded or received from the wireless device 510.

In some implementations, the wireless device 510 may not transmit acknowledgements (ACKs) or negative acknowledgements (NACKs) in response to receiving companion radio transmissions. An AP 505 may determine whether the wireless device 510 decoded a companion radio transmission based on receiving an expected message from the wireless device 510 using the primary radio. For example, if a companion radio transmission indicates that the AP 505 includes buffered data waiting to transmitted to the wireless device 510, the wireless device 510 may activate (e.g., power-up) its primary radio to receive the buffered data. The AP 505 may determine whether the companion radio transmission was successfully decoded or not based on receiving a message from the primary radio of the wireless device 510. In examples, the AP 505 may select data rates for future companion radio transmissions based on whether expected responses to companion radio transmissions are received by the AP 505 from the wireless device 510.

At block 515, the wireless device 510 may enter a low-power mode (e.g., a sleep mode). During the low-power mode, the wireless device 510 may deactivate or reduce the activity of a number of components, including its primary radio. In some cases, entering the low-power mode may also include activating some components such as a companion radio (e.g., wake-up radio). In some examples, as part of block 515, the wireless device 510 may perform procedures similar to those described with reference to block 415. As such, a full description of such procedures is not repeated here.

At block 520, the AP 505 may determine whether an action should be taken by the wireless device 510 that is currently in low-power mode. The AP 505 may determine actions that may be observed directly by the AP 505. For example, the AP 505 may determine that buffered data is waiting to be transferred to the wireless device 510. Because the wireless device 510 is in a low-power mode, the wireless device 510 may not be configured to receive the buffered data immediately via the primary radio of the wireless device 510.

The AP 505 may transmit a companion radio transmission 525 indicating that buffered data is waiting at the AP 505 to be transmitted to the wireless device 510. The companion radio transmission 525 may include a command for the wireless device 510 to exit its low-power mode, activate its primary radio, and/or communicate with the AP 505 via the primary radio. The companion radio transmission 525 may be transmitted during a specific time interval specified by a transmission schedule. The companion radio transmission 525 may be an example of a traffic indication message (or map) or a delivery traffic indication message (or map).

At block 530, the AP 505 may wait for a time duration for a response to the companion radio transmission 525 from the wireless device 510. If the AP 505 does not receive a response to the companion radio transmission 525 within the time duration, the AP 505 may conclude that the wireless device 510 may not have successfully decoded the companion radio transmission 525.

In some examples, to determine whether the time duration is satisfied, the AP 505 may identify when the companion radio transmission 525 was transmitted. The AP 505 may compare time since the transmission time to a time threshold. Once the time since the transmission time exceeds the time threshold, the AP 505 may conclude that the wireless device 510 may not have successfully decoded the companion radio transmission 525. In some examples, the AP 505 may initiate a timer when the companion radio transmission 525 is transmitted.

In some examples, the AP 505 may optionally retransmit the companion radio transmission 525-a to the wireless device 510 based on the time duration expiring with no response from the wireless device 510. The AP 505 may continue to retransmit the companion radio transmission 525 until a retransmission threshold is reached. The retransmission threshold may include one transmission, two transmissions, three transmissions, four transmissions, etc.

At block 535, the AP 505 may select the data rate for future companion radio transmissions based on the retransmission threshold being satisfied (whether by one transmission or multiple transmissions). For example, if the AP 505 determines that the wireless device 510 has failed to successfully decode the companion radio transmission 525, the AP 505 may select a data rate for companion radio transmission 540 that is less than the data rate for companion radio transmission 525. In this manner, the AP 505 may extend the coverage area of the companion radio using the reduced data rate. In some examples, the AP 505 may increase the data rate for future companion radio transmissions based on wireless device 510 successfully decoding the companion radio transmission 525 or successfully decoding a plurality of companion radio transmissions.

At block 545, upon receiving the companion radio transmission 540, the wireless device 510 may decode the companion radio transmission 540. As part of decoding, the wireless device 510 may determine if the AP 505 has requested any actions by the wireless device 510 (e.g., activate primary radio to receive buffered data).

At block 550, if the companion radio transmission 540 indicates that the AP 505 has buffered data for the wireless device 510, the wireless device 510 may activate its primary radio to communicate with the AP 505. The wireless device 510 may transmit a response 555 to the companion radio transmission 540 using the primary radio based on the decoded companion radio transmission 540.

Upon receiving the response 555, the AP 505 may determine that the selected data rate is appropriate for transmitting future companion radio transmissions 560 to the wireless device 510. After selecting a new data rate at 535, if the AP 505 does not receive the response 555, the AP 505 may select another data rate for future companion radio transmissions. In some examples, performing the actions requested by the AP 505, the wireless device 510 may re-enter the low-power mode.

The communication scheme 500 illustrates an example of reducing a data rate in response to companion radio transmission failing to be decoded by the wireless device 510. In other examples, the AP 505 may increase the data rate of future companion radio transmissions when certain conditions are met. For example, if the AP 505 determines that a number of companion radio transmissions 525 are successfully decoded by the wireless device 510, the AP 505 may select a data rate for future companion radio transmissions that is greater than a former data rate. Modifications to communication scheme 500 to account for increases in data rates may be readily appreciated by a person of ordinary skill in the art. In some examples, the communication scheme 500 may be used in combination with communication scheme 400 to perform data rate adaptation for companion radio transmissions.

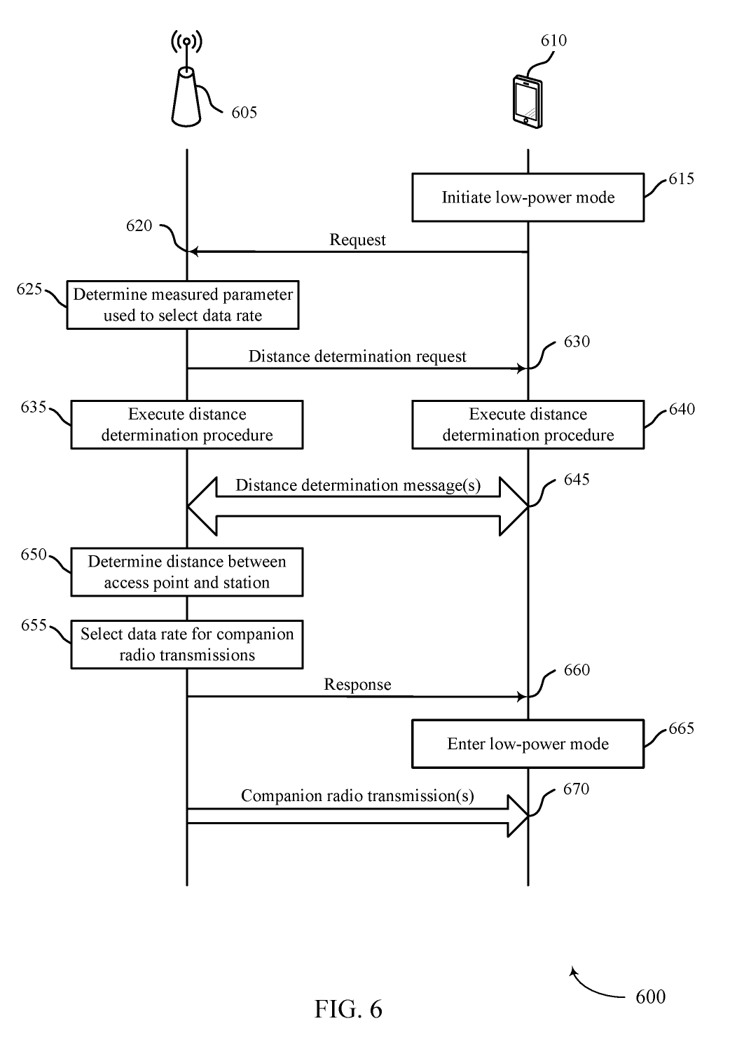

FIG. 6 illustrates an example of a communication scheme 600 that supports data rate selection for wake-up radio transmissions in accordance with various aspects of the present disclosure. In some examples, the communication scheme 600 may implement aspects of wireless communication system 100. The communication scheme 600 illustrates how an AP 605 and a wireless device 610 may perform data rate selection for companion radio transmissions. The AP 605 may be an example of the APs 105, 105-a, 305, 405, and 505 described with reference to FIGS. 1-5. The wireless device 610 may be an example of the wireless devices 115, 115-a, 310, 410, and 510 described with reference to FIGS. 1-5.

The communication scheme 600 illustrates an example of a companion radio data rate adaptation procedure based on measurements made using a primary radio of the wireless device 610. In the data rate adaptation procedure illustrated by the communication scheme 600, the AP 605 may adjust or select data rates for future companion radio transmissions based on one or more parameters or signal characteristics measured or determined using messages communicated using the primary radio. For example, a data rate for companion radio transmissions may be selected based on a distance between the AP 605 and the wireless device 610. In other examples, a data rate for companion radio transmissions may be selected based on an RSSI of primary radio communications. In some examples, the data rate adaptation procedure illustrated by the communication scheme 600 may be performed before the wireless device 610 enters a low-power mode.

At block 615, the wireless device 610 may initiate a low-power mode. As such, the wireless device 610 may determine to enter a low-power mode based on inactivity. As part of entering the low-power mode, the wireless device 610 may coordinate several items with the AP 605 before entering the low-power mode (e.g., a beacon schedule).

To coordinate entering the low-power mode with the AP 605, the wireless device 610 may transmit a low-power mode request 620 to the AP 605 using its primary radio. The request 620 may indicate that the wireless device 610 is entering a low-power mode.

In some examples, the AP 605 may initiate procedures for the wireless device 610 to enter a low-power mode. In such examples, the AP 605 may initiate the low-power mode procedures without the request message 620 or the response message 660. In some cases, the AP 605 may execute blocks 625-655 without receiving the request message 620 based on determining that the wireless device 610 should enter a low-power mode. In some of these same cases, the AP 605 may transmit a low-power mode message in place of response message 660. The low-power mode message may include similar information as the response message 660 (e.g., low-power mode parameters, beacon schedule, selected data rate, etc.).

At block 625, upon receiving the request 620, the AP 605 may determine a measured parameter of primary radio communications to use to select the data rate for companion radio transmissions. In the example illustrated in the communication scheme 600, the measured parameter is distance. In other examples, however, the measured parameter may be an RSSI of primary radio communications. In such RSSI examples, the AP 605 may measure the RSSI of the request 620 and/or other messages transmitted using the primary radio of the wireless device 610. Adjustments to the communication scheme 600 based on the measured RSSI may be appreciated by a person of ordinary skill in the art.

If the AP 605 determines to use distance between the AP 605 and the wireless device 610 as the measure parameter, the AP 605 may transmit a distance determination request 630 to the wireless device 610. The distance determination request 630 may cause both the AP 605 and the wireless device 610 to initiate a distance determination procedure at blocks 635, 640. As part of the distance determination procedure, the AP 605 and the wireless device 610 may exchange distance determination messages 645 using the primary radio of the wireless device 610.

In some examples, the distance determination procedure may be an example of a fine timing measurement (FTM) procedure. In an FTM procedure, the AP 605 and the wireless device 610 may exchange a series of messages (e.g., messages and ACKs) that include time transmission data. Based on the time difference between transmission and reception of these messages, the AP 605 may determine a distance between the AP 605 and the wireless device 610. In some cases, the distance determination procedure may include sending multiple sets of distance determination messages so that different distance results may be averaged to find a more correct vale.

At block 650, the AP 605 may determine the distance between the AP 605 and the wireless device 610 based on the distance determination procedure. In some examples, the distance between the AP 605 and the wireless device 610 may be determined using location-based methods, such as a global positioning system (GPS) based system. In such example, the AP 605 may determine the distance based on the location of the AP 605 and the location of the wireless device 610.

At block 655, the AP 605 may select a data rate for companion radio transmission based on the distance between the AP 605 and the wireless device 610. In other examples, the data rate for companion radio transmissions may be selected based on other parameters measured using primary radio communications (e.g., RSSI). To select the data rate, the AP 605 may determine whether the distance satisfies a distance threshold. If the distance threshold is satisfied, the AP 605 may select a lower data rate. In such examples, the AP 605 may attempt to extend the coverage area of the companion radio by transmitting companion radio transmissions at a lower data rate. In some examples, the AP 605 may choose a highest PHY rate that has a coverage range that corresponds to the distance.

The AP 605 may transmit a response 660 based on the request 620. The response 660 may authorize the wireless device 610 to enter a low-power mode. The response 660 may include information related to a beacon schedule. In some examples, the response 660 may indicate the selected data rate for companion radio transmissions. In other examples, each companion radio transmission may indicate its data rate.

At block 665, upon receiving the response 660, the wireless device 610 may enter a low-power mode. During the low-power mode, the wireless device 610 may deactivate or reduce the activity of a number of components, including its primary radio. In some cases, entering the low-power mode may also include activating some components such as a companion radio (e.g., wake-up radio). In some examples, as part of block 665, the wireless device 610 may perform procedures similar to those described with reference to block 415. As such, a full description of such procedures is not repeated here.

While the wireless device 610 is in a low-power mode, the AP 605 may transmit companion radio transmissions 670 to the companion radio of the wireless device 610 using the selected data rate. In some examples, the communication scheme 600 may be used in combination with communication scheme 400, the communication scheme 500, or combinations thereof to perform data rate adaptation for companion radio transmissions. For example, communication scheme 600 may be used to pre-select a data rate before the wireless device 610 enters a low-power mode and the communication scheme 400 and/or the communication scheme 500 may be used to modify a data rate after the wireless device 610 is in the low-power mode.

In some examples, the communication scheme 600 may be implemented at a different time, other than before entering a low-power mode. For example, the communication scheme 600 may be implemented when a communication link between the AP 605 and the wireless device 610 is established. In other examples, the communication scheme 600 may periodically be initiated (by either entity) while the wireless device 610 is in a normal mode (e.g., a non-low-power mode).

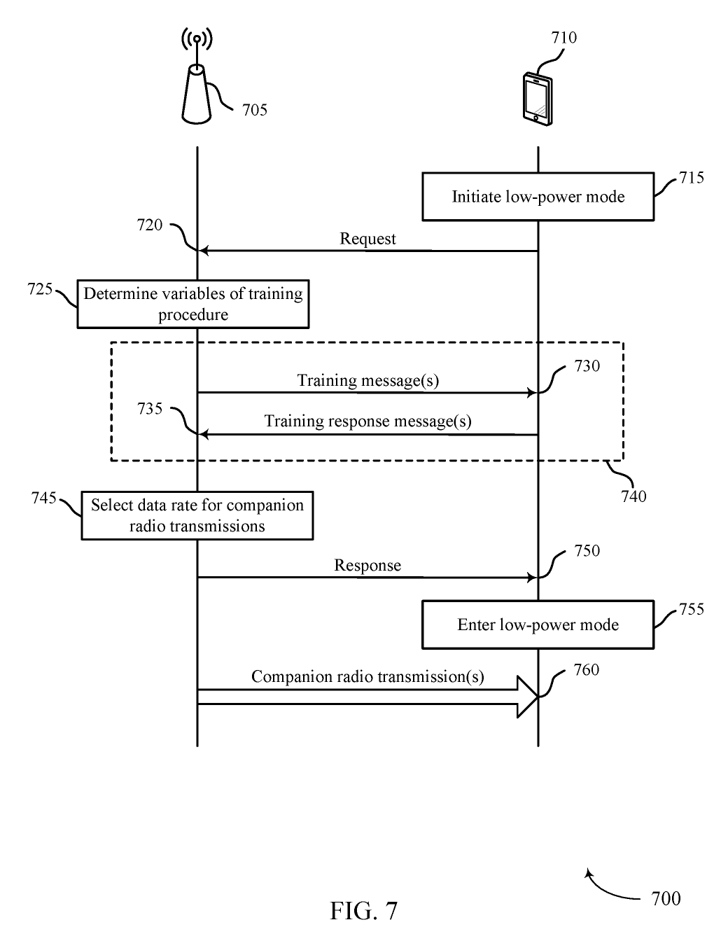

FIG. 7 illustrates an example of a communication scheme 700 that supports data rate selection for wake-up radio transmissions in accordance with various aspects of the present disclosure. In some examples, the communication scheme 700 may implement aspects of wireless communication system 100. The communication scheme 700 illustrates how an AP 705 and a wireless device 710 may perform data rate selection for companion radio transmissions. The AP 705 may be an example of the APs 105, 105-1, 305, 405, 505, and 605 described with reference to FIGS. 1-6. The wireless device 710 may be an example of the wireless devices 115, 115-a, 310, 410, 510, and 610 described with reference to FIGS. 1-6.

The communication scheme 700 illustrates an example of a companion radio data rate adaptation procedure based on a training procedure implemented using the primary radio of the wireless device 710. In the data rate adaptation procedure illustrated by the communication scheme 700, the AP 705 may adjust or select data rates for future companion radio transmissions based on exchanging training messages (e.g., training packets) using the primary radio of the wireless device 710.

At block 715, the wireless device 710 may initiate a low-power mode. As such, the wireless device 710 may determine to enter a low-power mode based on inactivity. As part of entering the low-power mode, the wireless device 710 may coordinate several items with the AP 705 before entering the low-power mode (e.g., beacon schedule). In some examples, as part of block 715, the wireless device 710 may perform procedures similar to those described with reference to block 615. As such, a full description of such procedures is not repeated here.

To coordinate entering the low-power mode with the AP 705, the wireless device 710 may transmit a low-power mode request 720 to the AP 705 using its primary radio. The request 720 may indicate that the wireless device 710 is entering a low-power mode. In some cases, the request 720 may be an example of the request 620 described with reference to FIG. 6.

In some examples, the AP 705 may initiate procedures for the wireless device 710 to enter a low-power mode. In such examples, the AP 705 may initiate the low-power mode procedures without the request message 720 or the response message 750. In some cases, the AP 705 may execute block 725-745 without receiving the request message 720 based on determining that the wireless device 710 should enter a low-power mode. In some of these same cases, the AP 705 may transmit a low-power mode message in place of response message 750. The low-power mode message may include similar information as the response message 750 (e.g., low-power mode parameters, beacon schedule, selected data rate, etc.).

At block 725, upon receiving the request 720, the AP 705 may determine one or more variables of a training procedure. In some examples, the AP 705 may identify which data rates are available to be used for companion radio transmissions. In other examples, the AP 705 may dynamically identify available data rates based on a variety of factors. In some examples, the AP 705 may identify the available data rates for companion radio transmissions based on network conditions, the RAT being used to communicate via the primary radio, the data rates of the RAT used to communicate via the primary radio, or combinations thereof. The AP 705 may configure training messages 730 based on the variables of the training procedure.

The AP 705 may transmit a training message 730 based on the variables of the training procedure. The training message 730 may be transmitted to a companion radio (e.g., wake-up radio) of the wireless device 710. In some examples, the training message 730 may be transmitted to a primary radio of the wireless device 710. The training message 730 may be configured to provide information about the available data rates for companion radio transmissions. Such information may be provided in a variety of ways. In some examples, the training message 730 may be an example of a training packet.

In some examples, the AP 705 may transmit a training message 730 at each available data rate for companion radio transmissions. For example, if two data rates for companion radio transmissions exist, the AP 705 may transmit a first training message at the first data rate and a second training message at the second data rate.

In some examples, the AP 705 may transmit a training message 730 at data rates associated with each available data rate for companion radio transmissions. The AP 705 may transmit training messages 730 to the companion radio of the wireless device 710. In other examples, however, the AP 705 may transmit the training messages 730 to a primary radio of the wireless device 710. In such examples, the AP 705 may determine a data rate for primary radio transmissions that may be related to a data rate for companion radio transmissions. For example, if two data rates for companion radio transmissions exist, the AP 705 may identify the related data rates for the primary radio communications. In such examples, the AP 705 transmit a first training message at a first data rate for primary radio communications to the primary radio of the wireless device 710 and a second training message at the second data rate for primary radio communications to the primary radio of the wireless device 710.

In some examples, the training message 730 may include information about the data rates available for companion radio communications. In such examples, the wireless device 710 may decode the training message 730 and make determinations based on the data included in the training message 730 rather than the characteristics of the training message 730. In some examples, the training procedure may include any combination of these different training messages 730.

Upon receiving the training message(s) 730, the wireless device 710 may determine a number of training statistics based on the received training message(s) 730. For example, the wireless device 710 may identify a number of successfully decoded training messages corresponding to a particular data rate for companion radio transmissions. In other examples, the wireless device 710 may measure other characteristics of the training message(s) 730. In other examples, the wireless device may decode the training message(s) 730 and determine information using the decoded information. In yet other examples, the wireless device 710 may perform any combination of these procedures.

After determining the training statistics, the wireless device 710 may transmit one or more training response messages 735 using its primary radio. The training response message 735 may indicate the training statistics determined by the wireless device 710. In some examples, a single training response message 735 may be generated and transmitted for a plurality of training messages 730. In other examples, a training response message 735 may be generated and transmitted for each received training message 730. In some examples, the training response message 735 may be an example of a training response packet.

As illustrated by box 740, sets of training messages 730 and training response messages 735 may be exchanged repeatedly to determine the training statistics. For example, the AP 705 and the wireless device 710 may exchange several sets of training messages 730 and training response messages 735 to identify weighted training statistics (e.g., averaged). In other examples, bursts of training messages 730 may transmitted to the wireless device 710. Each burst may include training messages dedicated to different data rates, multiple training messages dedicated to the same data rate, or combinations thereof. The wireless device 710 may generate and transmit training response messages that are based on the bursts of training messages. In some examples, sets of burst training messages and training response messages may be exchanged to determine weighted training statistics.

At block 745, the AP 705 may select a data rate for companion radio transmissions based on the information included in the training response message(s) 735. To select the data rate, the AP 705 may determine whether the training statistics satisfy one or more training thresholds. For instance, a training threshold may exist for each available data rate. If the training statistics satisfy a given set of set of training thresholds, a particular data rate for companion radio transmission may be selected. For example, if there are three available data rates, a first data rate may be selected if a first training threshold is satisfied, a second data rate may be selected if the first training threshold and a second training threshold are satisfied, and a third data rate may be selected if the first training threshold, the second training threshold, and a third training threshold are satisfied.

The AP 705 may transmit a response 750 based on the request 720. The response 750 may authorize the wireless device 710 to enter a low-power mode. The response 750 may include information related to a beacon schedule. In some examples, the response 750 may indicate the selected data rate for companion radio transmissions. In other examples, each companion radio transmission may indicate its data rate. The response 750 may be an example of the response 660 described with reference to FIG. 6.

At block 755, upon receiving the response 750, the wireless device 710 may enter a low-power mode. During the low-power mode, the wireless device 710 may deactivate or reduce the activity of a number of components, including its primary radio. In some cases, entering the low-power mode may also include activating some components such as a companion radio (e.g., wake-up radio). In some examples, as part of block 755, the wireless device 710 may perform procedures similar to those described with reference to block 415. As such, a full description of such procedures is not repeated here.

While the wireless device 710 is in a low-power mode, the AP 705 may transmit companion radio transmissions 760 to the companion radio of the wireless device 710 using the selected data rate. In some examples, the communication scheme 700 may be used in combination with communication scheme 400, the communication scheme 500, the communication scheme 600, or combinations thereof to perform data rate adaptation for companion radio transmissions. For example, communication scheme 700 may be used to pre-select a data rate before the wireless device 710 enters a low-power mode and the communication scheme 400 and/or the communication scheme 500 may be used to modify a data rate after the wireless device 710 is in the low-power mode. In some examples, a combination of communication scheme 600 and communication scheme 700 may be used to pre-select a data rate before the wireless device 710 enters a low-power mode.

In some examples, the communication scheme 700 may be implemented at a different time, other than before entering a low-power mode. For example, the communication scheme 700 may be implemented when a communication link between the AP 705 and the wireless device 710 is established. In other examples, the communication scheme 700 may periodically be initiated (by either entity) while the wireless device 710 is in a normal mode (e.g., a non-low-power mode). In some examples, the AP 705 may communicate to the wireless device 710 a training schedule that indicates the periodicity of a periodic training procedure. In other examples, the communication scheme 700 may be aperiodically initiated by the AP 705 based on one or more trigger conditions being satisfied.

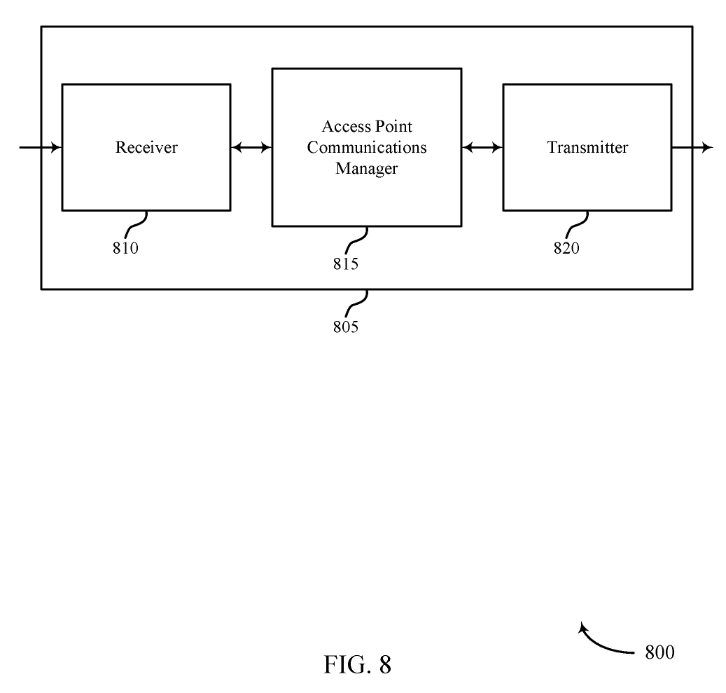

FIG. 8 shows a block diagram 800 of an AP 805 that supports data rate selection for wake-up radio transmissions in accordance with aspects of the present disclosure. AP 805 may be an example of aspects of an AP 105, 105-a, 305, 405, 505, 605, and 705 as described herein. AP 805 may include receiver 810, access point communications manager 815, and transmitter 820. AP 805 may also include a processor. Each of these components may be in communication with one another (e.g., via one or more buses).

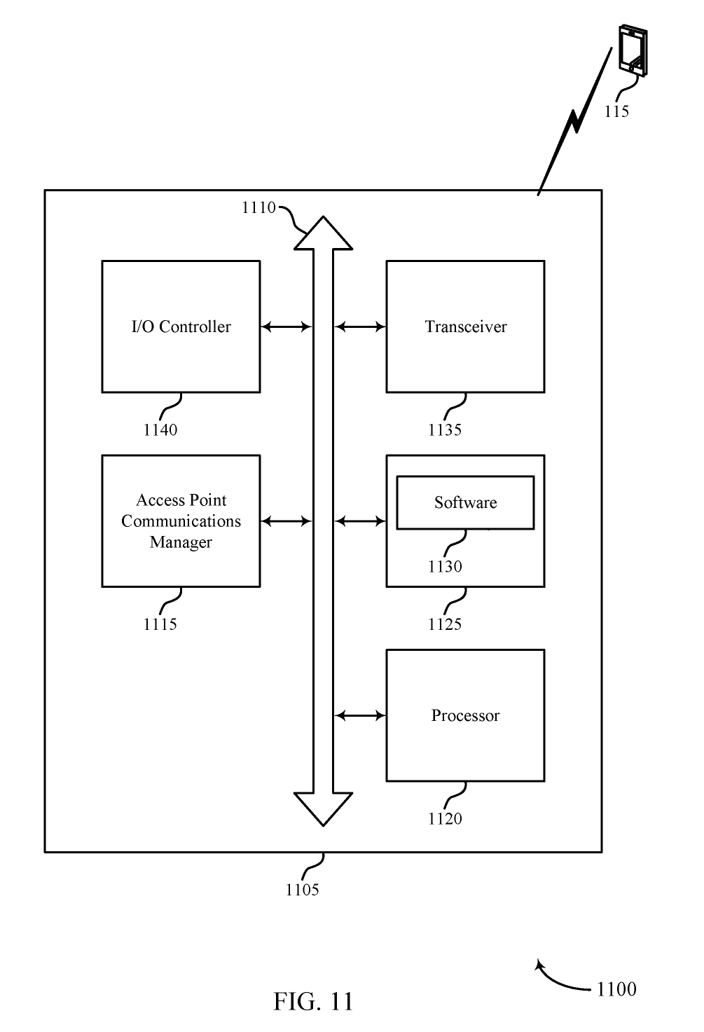

Receiver 810 may receive information such as packets, user data, or control information associated with various information channels (e.g., control channels, data channels, and information related to data rate selection for wake-up radio transmissions, etc.). Information may be passed on to other components of the device. The receiver 810 may be an example of aspects of the transceiver 1135 described with reference to FIG. 11. The receiver 810 may utilize a single antenna or a set of antennas.

Access point communications manager 815 may be an example of aspects of the access point communications manager 1115 described with reference to FIG. 11. Access point communications manager 815 and/or at least some of its various sub-components may be implemented in hardware, software executed by a processor, firmware, or any combination thereof If implemented in software executed by a processor, the functions of the access point communications manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. Access point communications manager 815 and/or at least some of its various sub-components may be physically located at various positions, including being distributed such that portions of functions are implemented at different physical locations by one or more physical devices. In some examples, access point communications manager 815 and/or at least some of its various sub-components may be a separate and distinct component in accordance with various aspects of the present disclosure. In other examples, access point communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Access point communications manager 815 may determine that a parameter associated with a first signal transmitted to a wake-up radio of a station at a first data rate satisfies a threshold and select a second data rate less than the first data rate based on determining that the parameter satisfies the threshold.

Transmitter 820 may transmit signals generated by other components of the device. In some examples, transmitter 820 may be collocated with a receiver 810 in a transceiver module. For example, transmitter 820 may be an example of aspects of the transceiver 1135 described with reference to FIG. 11. Transmitter 820 may utilize a single antenna or a set of antennas. Transmitter 820 may transmit a second signal to the wake-up radio of the station at the second data rate.

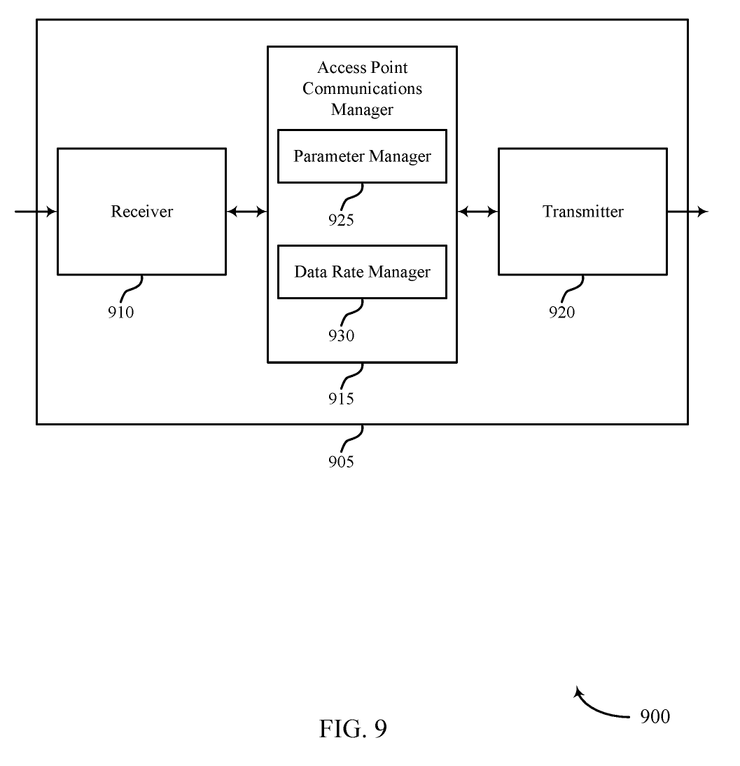

FIG. 9 shows a block diagram 900 of an AP 905 that supports data rate selection for wake-up radio transmissions in accordance with aspects of the present disclosure. AP 905 may be an example of aspects of a AP 805 or an AP 105, 105-a, 305, 405, 505, 605, and 705 as described with reference to FIG. 8. AP 905 may include receiver 910, access point communications manager 915, and transmitter 920. AP 905 may also include a processor. Each of these components may be in communication with one another (e.g., via one or more buses).

Receiver 910 may receive information such as packets, user data, or control information associated with various information channels (e.g., control channels, data channels, and information related to data rate selection for wake-up radio transmissions, etc.). Information may be passed on to other components of the device. Receiver 910 may be an example of aspects of transceiver 1135 described with reference to FIG. 11. Receiver 910 may utilize a single antenna or a set of antennas.

Access point communications manager 915 may be an example of aspects of access point communications manager 1115 described with reference to FIG. 11. Access point communications manager 915 may also include parameter manager 925 and data rate manager 930.

Parameter manager 925 may determine that a parameter associated with a first signal transmitted to a wake-up radio of a station at a first data rate satisfies a threshold and identify a second parameter based on a second set of conditions different from a first set of conditions used to identify the parameter, where selecting the second data rate is based on the second parameter and the parameter.

Data rate manager 930 may select a second data rate less than the first data rate based on determining that the parameter satisfies the threshold. In some cases, the signal transmitted to the wake-up radio indicates at which data rate the signal was transmitted.

Transmitter 920 may transmit signals generated by other components of the device. In some examples, transmitter 920 may be collocated with receiver 910 in a transceiver module. For example, transmitter 920 may be an example of aspects of transceiver 1135 described with reference to FIG. 11. Transmitter 920 may utilize a single antenna or a set of antennas.

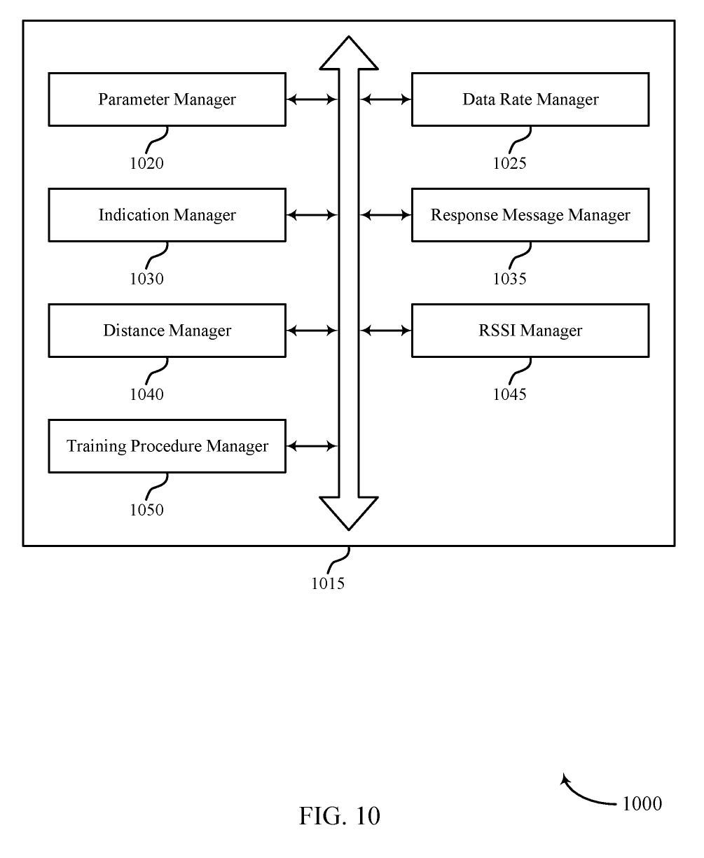

FIG. 10 shows a block diagram 1000 of access point communications manager 1015 that supports data rate selection for wake-up radio transmissions in accordance with aspects of the present disclosure. Access point communications manager 1015 may be an example of aspects of access point communications manager 815, access point communications manager 915, or access point communications manager 1115 described with reference to FIGS. 8, 9, and 11. Access point communications manager 1015 may include parameter manager 1020, data rate manager 1025, indication manager 1030, response message manager 1035, distance manager 1040, RSSI manager 1045, and training procedure manager 1050. Each of these modules may communicate, directly or indirectly, with one another (e.g., via one or more buses).

Parameter manager 1020 may determine that a parameter associated with a first signal transmitted to a wake-up radio of a station at a first data rate satisfies a threshold and identify a second parameter based on a second set of conditions different from a first set of conditions used to identify the parameter, where selecting a second data rate is based on the second parameter and the parameter.

Data rate manager 1025 may select a second data rate less than the first data rate based on determining that the parameter satisfies the threshold. In some cases, the signal transmitted to the wake-up radio indicates at which data rate the signal was transmitted.

Indication manager 1030 may receive an indication from the station that the station failed to decode two or more consecutive packets transmitted at the first data rate, where determining that the parameter satisfies the threshold is based on receiving the indication and transmit a beacon at the first data rate at a predetermined time based on a beacon schedule. In some cases, the indication that the station failed to decode the two or more consecutive packets indicates that the station failed to decode two consecutive beacons transmitted at the first data rate.

Response message manager 1035 may determine that an expected message from the station failed to be received using a primary radio of the station, where determining that the parameter satisfies the threshold is based on determining that the expected message failed to be received and transmit a traffic indication message to the wake-up radio of the station at the first data rate based on identifying buffered data for the station, where the expected message includes a response to the traffic indication message. In some cases, the traffic indication message includes an indication for the station to communicate with the access point using its primary radio.

Distance manager 1040 may identify a distance between the access point and the station, where determining that the parameter satisfies the threshold is based on the distance between the access point and the station, determine that the distance satisfies a distance threshold, where the second data rate is selected based on the distance threshold being satisfied, and initiate a fine timing measurement (FTM) procedure, where the distance is identified based on the FTM procedure.

RSSI manager 1045 may identify a received signal strength indicator (RSSI) associated with the station, where determining that the parameter satisfies the threshold is based on the RSSI.

Training procedure manager 1050 may transmit a first training message at the first data rate to the wake-up radio of the station, the first training message being associated with the signal transmitted to the wake-up radio of the station at the first data rate, receive a training response message from the primary radio of the station based on the first training message, where determining that the parameter satisfies the threshold is based on the training response message, and transmit a second training message at the second data rate to the primary radio of the station, the second training message being associated with the signal transmitted to the wake-up radio of the station at the first data rate, where the training response message is based on the first training message and the second training message. In some cases, the first training message is transmitted periodically based on a training schedule.

FIG. 11 shows a diagram of a system 1100 including a device 1105 that supports data rate selection for wake-up radio transmissions in accordance with aspects of the present disclosure. Device 1105 may be an example of or include the components of AP 805, AP 905, or an AP 105, 105-a, 305, 405, 505, 605, and 705 as described above, e.g., with reference to FIGS. 8 and 9. Device 1105 may include components for bi-directional voice and data communications including components for transmitting and receiving communications, including access point communications manager 1115, processor 1120, memory 1125, software 1130, transceiver 1135, and I/O controller 1140. These components may be in electronic communication via one or more buses (e.g., bus 1110).

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting data rate selection for wake-up radio transmissions).

Memory 1125 may include random access memory (RAM) and read only memory (ROM). Memory 1125 may store computer-readable, computer-executable software 1130 including instructions that, when executed, cause the processor to perform various functions described herein. In some cases, memory 1125 may contain, among other things, a basic input/output system (BIOS) which may control basic hardware or software operation such as the interaction with peripheral components or devices.

Software 1130 may include code to implement aspects of the present disclosure, including code to support data rate selection for wake-up radio transmissions. Software 1130 may be stored in a non-transitory computer-readable medium such as system memory or other memory. In some cases, software 1130 may not be directly executable by the processor but may cause a computer (e.g., when compiled and executed) to perform functions described herein.

Transceiver 1135 may communicate bi-directionally, via one or more antennas, wired, or wireless links as described above. For example, transceiver 1135 may represent a wireless transceiver and may communicate bi-directionally with another wireless transceiver. Transceiver 1135 may also include a modem to modulate the packets and provide the modulated packets to the antennas for transmission, and to demodulate packets received from the antennas.

I/O controller 1140 may manage input and output signals for device 1105. I/O controller 1140 may also manage peripherals not integrated into device 1105. In some cases, I/O controller 1140 may represent a physical connection or port to an external peripheral. In some cases, I/O controller 1140 may utilize an operating system such as iOS®, ANDROID®, MS-DOS®, MS-WINDOWS®, OS/2®, UNIX®, LINUX®, or another known operating system. In other cases, I/O controller 1140 may represent or interact with a modem, a keyboard, a mouse, a touchscreen, or a similar device. In some cases, I/O controller 1140 may be implemented as part of a processor. In some cases, a user may interact with device 1105 via I/O controller 1140 or via hardware components controlled by I/O controller 1140.

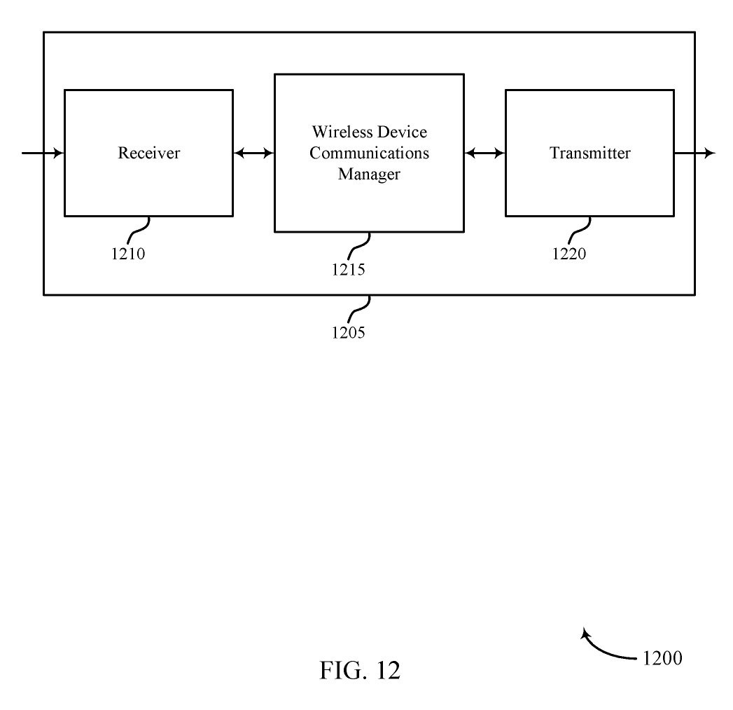

FIG. 12 shows a block diagram 1200 of a wireless device 1205 that supports data rate selection for wake-up radio transmissions in accordance with aspects of the present disclosure. Wireless device 1205 may be an example of aspects of a wireless device 115, 115-a, 310, 410, 510, 610, and 710 as described herein. Wireless device 1205 may include receiver 1210, wireless device communications manager 1215, and transmitter 1220. Wireless device 1205 may also include a processor. Each of these components may be in communication with one another (e.g., via one or more buses).

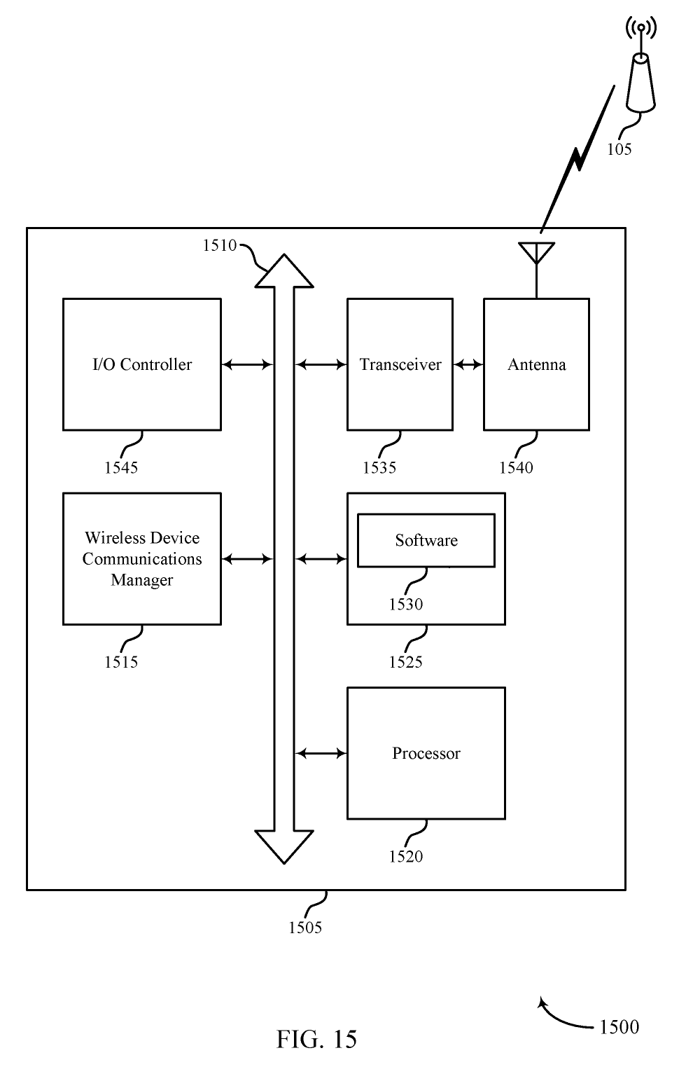

Receiver 1210 may receive information such as packets, user data, or control information associated with various information channels (e.g., control channels, data channels, and information related to data rate selection for wake-up radio transmissions, etc.). Information may be passed on to other components of the device. Receiver 1210 may be an example of aspects of transceiver 1535 described with reference to FIG. 15. Receiver 1210 may utilize a single antenna or a set of antennas. Receiver 1210 may receive a second signal at a second data rate less than the first data rate using the wake-up radio of the station based on transmitting the message.

Wireless device communications manager 1215 may be an example of aspects of wireless device communications manager 1515 described with reference to FIG. 15.

Wireless device communications manager 1215 and/or at least some of its various sub-components may be implemented in hardware, software executed by a processor, firmware, or any combination thereof If implemented in software executed by a processor, the functions of the wireless device communications manager 1215 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The wireless device communications manager 1215 and/or at least some of its various sub-components may be physically located at various positions, including being distributed such that portions of functions are implemented at different physical locations by one or more physical devices. In some examples, wireless device communications manager 1215 and/or at least some of its various sub-components may be a separate and distinct component in accordance with various aspects of the present disclosure. In other examples, wireless device communications manager 1215 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Wireless device communications manager 1215 may determine that a parameter associated with a first signal transmitted by an access point to the wake-up radio of the station at a first data rate satisfies a threshold.

Transmitter 1220 may transmit signals generated by other components of the device. In some examples, transmitter 1220 may be collocated with a receiver 1210 in a transceiver module. For example, transmitter 1220 may be an example of aspects of the transceiver 1535 described with reference to FIG. 15. Transmitter 1220 may utilize a single antenna or a set of antennas. Transmitter 1220 may transmit a message to the access point using the primary radio of the station based on determining that the parameter satisfies the threshold.

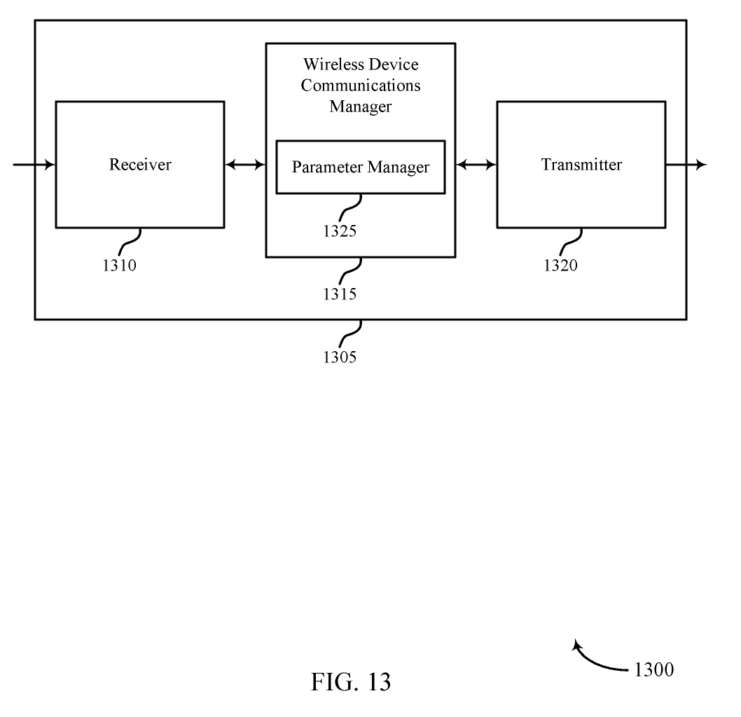

FIG. 13 shows a block diagram 1300 of wireless device 1305 that supports data rate selection for wake-up radio transmissions in accordance with aspects of the present disclosure. Wireless device 1305 may be an example of aspects of a wireless device 1205 or a wireless device 115, 115-a, 310, 410, 510, 610, and 710 as described with reference to FIG. 12. Wireless device 1305 may include receiver 1310, wireless device communications manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to data rate selection for wake-up radio transmissions, etc.). Information may be passed on to other components of the device. Receiver 1310 may be an example of aspects of the transceiver 1535 described with reference to FIG. 15. Receiver 1310 may utilize a single antenna or a set of antennas.

Wireless device communications manager 1315 may be an example of aspects of wireless device communications manager 1515 described with reference to FIG. 15. Wireless device communications manager 1315 may also include parameter manager 1325.

Parameter manager 1325 may determine that a parameter associated with a first signal transmitted by an access point to the wake-up radio of the station at a first data rate satisfies a threshold.

Transmitter 1320 may transmit signals generated by other components of the device. In some examples, transmitter 1320 may be collocated with a receiver 1310 in a transceiver module. For example, transmitter 1320 may be an example of aspects of transceiver 1535 described with reference to FIG. 15. Transmitter 1320 may utilize a single antenna or a set of antennas.

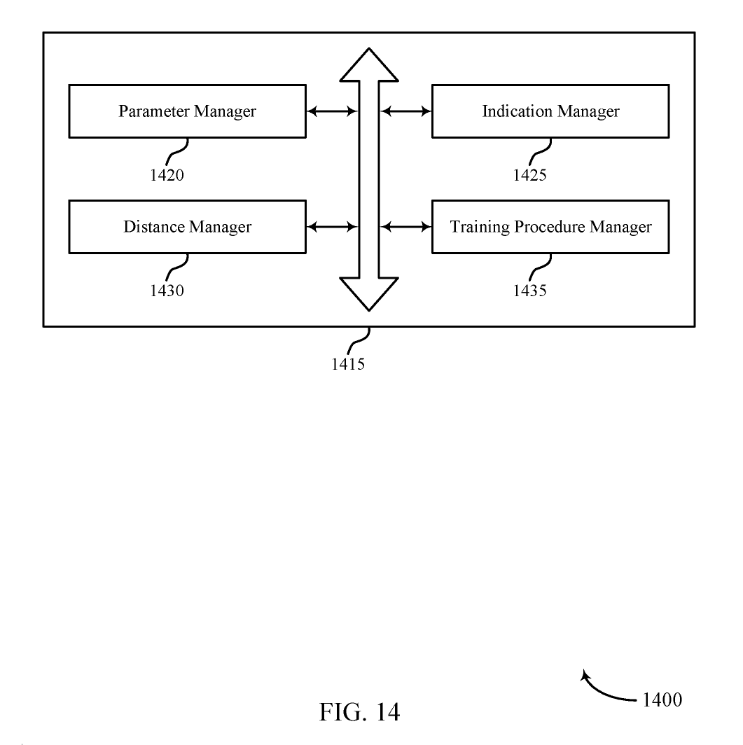

FIG. 14 shows a block diagram 1400 of wireless device communications manager 1415 that supports data rate selection for wake-up radio transmissions in accordance with aspects of the present disclosure. Wireless device communications manager 1415 may be an example of aspects of wireless device communications manager 1215, 1315, and 1515 described with reference to FIGS. 12, 13, and 15. Wireless device communications manager 1415 may include parameter manager 1420, indication manager 1425, distance manager 1430, and training procedure manager 1435. Each of these modules may communicate, directly or indirectly, with one another (e.g., via one or more buses).

Parameter manager 1420 may determine that a parameter associated with a first signal transmitted by an access point to the wake-up radio of the station at a first data rate satisfies a threshold.

Indication manager 1425 may determine that two or more consecutive packets transmitted at the first data rate to the wake-up radio of the station failed to be decoded, where determining that the parameter satisfies the threshold is based on failing to decode the two or more consecutive packets. In some cases, the message indicates that the station failed to decode two consecutive beacons transmitted at the first data rate to the wake-up radio of the station. In some cases, the two or more consecutive packets are beacons transmitted according to a beacon schedule.

Distance manager 1430 may receive a request initiating a fine timing measurement (FTM) procedure, where determining that the parameter satisfies the threshold is based on the FTM procedure.

Training procedure manager 1435 may receive a first training message at the first data rate using the wake-up radio of the station, where the first training message is associated with the first signal transmitted to the wake-up radio of the station at the first data rate, transmit a training response message using the primary radio of the station based on the first training message, where determining that the parameter satisfies the threshold is based on the training response message, and receive a second training message at the second data rate using the wake-up radio, where the second training message is associated with the first signal transmitted to the wake-up radio of the station at the first data rate, and the training response message is based on the first training message and the second training message.

FIG. 15 shows a diagram of a system 1500 including a wireless device 1505 that supports data rate selection for wake-up radio transmissions in accordance with aspects of the present disclosure. Device 1505 may be an example of or include the components of wireless device 115, 115-a, 310, 410, 510, 610, and 710 as described above, e.g., with reference to FIGS. 1 through 7. Device 1505 may include components for bi-directional voice and data communications including components for transmitting and receiving communications, including wireless device communications manager 1515, processor 1520, memory 1525, software 1530, transceiver 1535, antenna 1540, and I/O controller 1545. These components may be in electronic communication via one or more buses (e.g., bus 1510).

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting data rate selection for wake-up radio transmissions).

Memory 1525 may include RAM and ROM. The memory 1525 may store computer-readable, computer-executable software 1530 including instructions that, when executed, cause the processor to perform various functions described herein. In some cases, memory 1525 may contain, among other things, a BIOS which may control basic hardware or software operation such as the interaction with peripheral components or devices.

Software 1530 may include code to implement aspects of the present disclosure, including code to support data rate selection for wake-up radio transmissions. Software 1530 may be stored in a non-transitory computer-readable medium such as system memory or other memory. In some cases, software 1530 may not be directly executable by the processor but may cause a computer (e.g., when compiled and executed) to perform functions described herein.

Transceiver 1535 may communicate bi-directionally, via one or more antennas, wired, or wireless links as described above. For example, transceiver 1535 may represent a wireless transceiver and may communicate bi-directionally with another wireless transceiver. Transceiver 1535 may also include a modem to modulate the packets and provide the modulated packets to the antennas for transmission, and to demodulate packets received from the antennas.

In some cases, wireless device 1505 may include a single antenna 1540. However, in some cases wireless device 1505 may have more than one antenna 1540, which may be capable of concurrently transmitting or receiving multiple wireless transmissions.

I/O controller 1545 may manage input and output signals for wireless device 1505. I/O controller 1545 may also manage peripherals not integrated into wireless device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system. In other cases, I/O controller 1545 may represent or interact with a modem, a keyboard, a mouse, a touchscreen, or a similar device. In some cases, I/O controller 1545 may be implemented as part of a processor. In some cases, a user may interact with device 1505 via I/O controller 1545 or via hardware components controlled by I/O controller 1545.

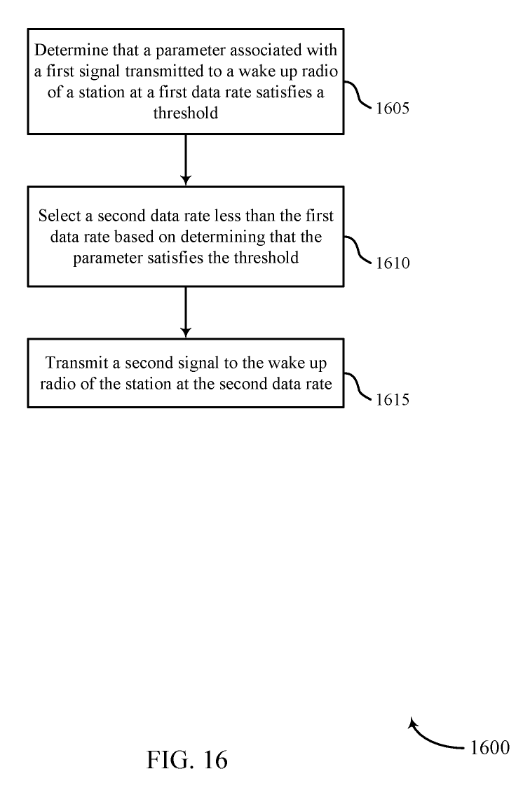

FIG. 16 shows a flowchart illustrating a method 1600 for data rate selection for wake-up radio transmissions in accordance with aspects of the present disclosure. The operations of method 1600 may be implemented by an AP 105 or its components as described herein. For example, the operations of method 1600 may be performed by access point communications manager 815, 915, 1015, and 1115 as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1605, the AP 105 may determine that a parameter associated with a first signal transmitted to a wake-up radio of a station at a first data rate satisfies a threshold. The operations of block 1605 may be performed according to the methods described herein. In certain examples, aspects of the operations of block 1605 may be performed by a parameter manager 815, 925, 1020, and 1115 as described with reference to FIGS. 8 through 11.

At block 1610, the AP 105 may select a second data rate less than the first data rate based at least in part on determining that the parameter satisfies the threshold. The operations of block 1610 may be performed according to the methods described herein. In certain examples, aspects of the operations of block 1610 may be performed by a data rate manager 815, 930, 1025, and 1115 as described with reference to FIGS. 8 through 11.

At block 1615, the AP 105 may transmit a second signal to the wake-up radio of the station at the second data rate. The operations of block 1615 may be performed according to the methods described herein. In certain examples, aspects of the operations of block 1615 may be performed by transmitter 820, 920, and 1135 as described with reference to FIGS. 8, 9 and 11.

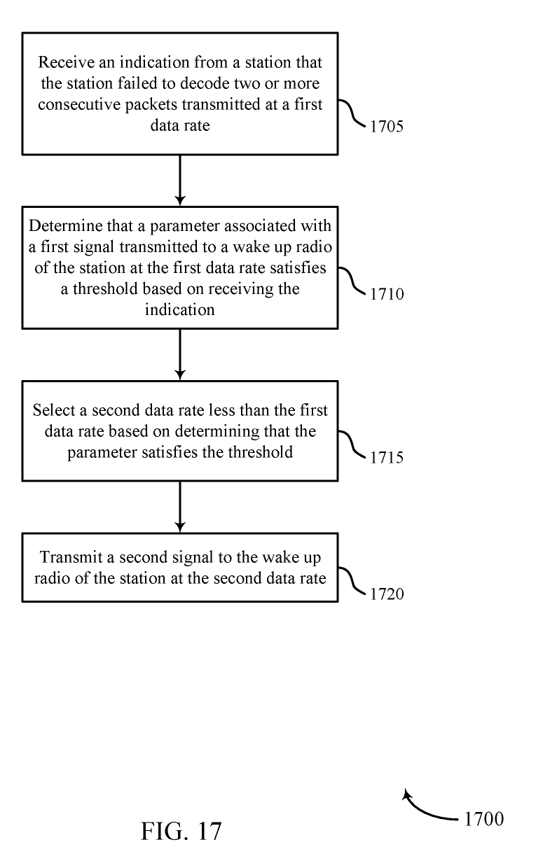

FIG. 17 shows a flowchart illustrating a method 1700 for data rate selection for wake-up radio transmissions in accordance with aspects of the present disclosure. The operations of method 1700 may be implemented by an AP 105 or its components as described herein. For example, the operations of method 1700 may be performed by access point communications manager 815, 915, 1015, and 1115 as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block, 1705 the AP 105 may receive an indication from a station that the station failed to decode two or more consecutive packets transmitted at a first data rate. The operations of block 1705 may be performed according to the methods described herein. In certain examples, aspects of the operations of block 1705 may be performed by indication manager 815, 915, 1030, and 1115 as described with reference to FIGS. 8 through 11.

At block 1710, the AP 105 may determine that a parameter associated with a first signal transmitted to a wake-up radio of the station at the first data rate satisfies a threshold based at least in part on receiving the indication. The operations of block 1710 may be performed according to the methods described herein. In certain examples, aspects of the operations of block 1710 may be performed by parameter manager 815, 925, 1020, and 1115 as described with reference to FIGS. 8 through 11.

At block 1715, the AP 105 may select a second data rate less than the first data rate based at least in part on determining that the parameter satisfies the threshold. The operations of block 1715 may be performed according to the methods described herein. In certain examples, aspects of the operations of block 1715 may be performed by data rate manager 815, 930, 1025, and 1115 as described with reference to FIGS. 8 through 11.

At block 1720, the AP 105 may transmit a second signal to the wake-up radio of the station at the second data rate. The operations of block 1720 may be performed according to the methods described herein. In certain examples, aspects of the operations of block 1720 may be performed by transmitter 820, 920, and 1135 as described with reference to FIGS. 8, 9 and 11.

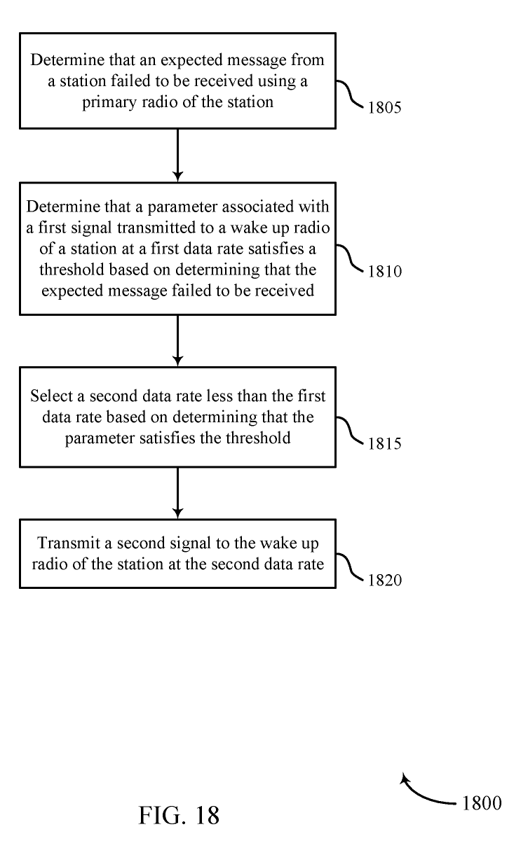

FIG. 18 shows a flowchart illustrating a method 1800 for data rate selection for wake-up radio transmissions in accordance with aspects of the present disclosure. The operations of method 1800 may be implemented by an AP 105 or its components as described herein. For example, the operations of method 1800 may be performed by access point communications manager 815, 915, 1015, and 1115 as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1805, the AP 105 may determine that an expected message from a station failed to be received using a primary radio of the station. The operations of block 1805 may be performed according to the methods described herein. In certain examples, aspects of the operations of block 1805 may be performed by response message manager 815, 915, 1035, and 1115 as described with reference to FIGS. 8 through 11.

At block 1810, the AP 105 may determine that a parameter associated with a first signal transmitted to a wake-up radio of the station at a first data rate satisfies a threshold based at least in part on determining that the expected message failed to be received. The operations of block 1810 may be performed according to the methods described herein. In certain examples, aspects of the operations of block 1810 may be performed by parameter manager 815, 925, 1020, and 1115 as described with reference to FIGS. 8 through 11.

At block 1815, the AP 105 may select a second data rate less than the first data rate based at least in part on determining that the parameter satisfies the threshold. The operations of block 1815 may be performed according to the methods described herein. In certain examples, aspects of the operations of block 1815 may be performed by data rate manager 815, 930, 1025, and 1115 as described with reference to FIGS. 8 through 11.

At block 1820, the AP 105 may transmit a second signal to the wake-up radio of the station at the second data rate. The operations of block 1820 may be performed according to the methods described herein. In certain examples, aspects of the operations of block 1820 may be performed by transmitter 820, 920, and 1135 as described with reference to FIGS. 8, 9, and 11.

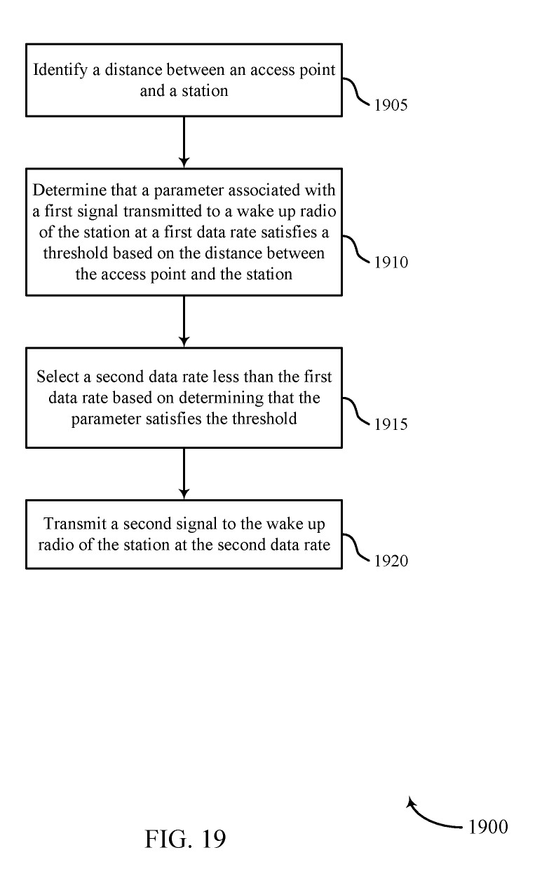

FIG. 19 shows a flowchart illustrating a method 1900 for data rate selection for wake-up radio transmissions in accordance with aspects of the present disclosure. The operations of method 1900 may be implemented by an AP 105 or its components as described herein. For example, the operations of method 1900 may be performed by access point communications manager 815, 915, 1015, and 1115 as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1905, the AP 105 may identify a distance between the AP 105 and a station 115. The operations of block 1905 may be performed according to the methods described herein. In certain examples, aspects of the operations of block 1905 may be performed by distance manager 815, 915, 1040, and 1115 as described with reference to FIGS. 8 through 11.

At block 1910, the AP 105 may determine that a parameter associated with a first signal transmitted to a wake-up radio of the station at a first data rate satisfies a threshold based at least in part on the distance between the AP 105 and the station 115. The operations of block 1910 may be performed according to the methods described herein. In certain examples, aspects of the operations of block 1910 may be performed by parameter manager 815, 925, 1020, and 1115 as described with reference to FIGS. 8 through 11.

At block 1915, the AP 105 may select a second data rate less than the first data rate based at least in part on determining that the parameter satisfies the threshold. The operations of block 1915 may be performed according to the methods described herein. In certain examples, aspects of the operations of block 1915 may be performed by data rate manager 815, 930, 1025, and 1115 as described with reference to FIGS. 8 through 11.

At block 1920, the AP 105 may transmit a second signal to the wake-up radio of the station at the second data rate. The operations of block 1920 may be performed according to the methods described herein. In certain examples, aspects of the operations of block 1920 may be performed by transmitter 820, 920 and 1135 as described with reference to FIGS. 8, 9, and 11.

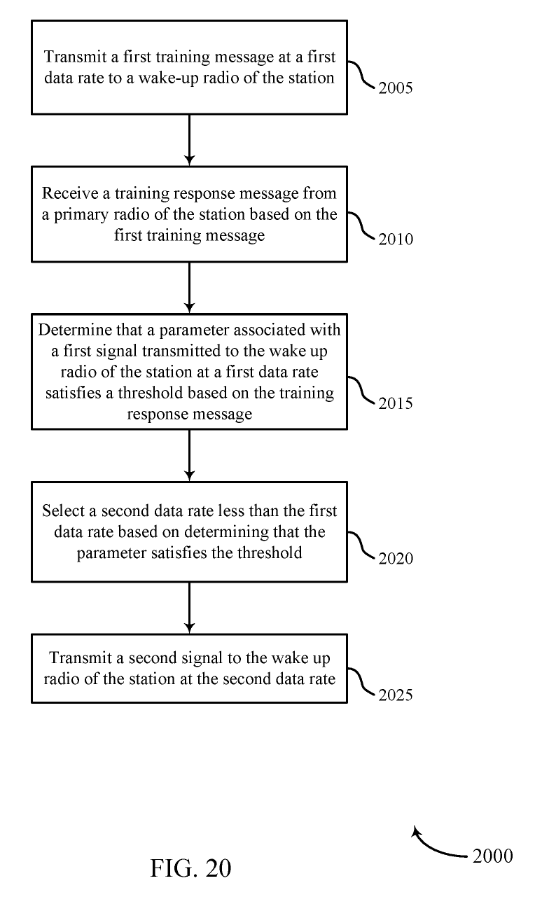

FIG. 20 shows a flowchart illustrating a method 2000 for data rate selection for wake-up radio transmissions in accordance with aspects of the present disclosure. The operations of method 2000 may be implemented by an AP 105 or its components as described herein. For example, the operations of method 2000 may be performed by access point communications manager 815, 915, 1015, and 1115 as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 2005, the AP 105 may transmit a first training message at a first data rate to the wake-up radio of the station. The operations of block 2005 may be performed according to the methods described herein. In certain examples, aspects of the operations of block 2005 may be performed by training procedure manager 815, 915, 1050, and 1115 as described with reference to FIGS. 8 through 11.

At block 2010, the AP 105 may receive a training response message from a primary radio of the station based at least in part on the first training message. The operations of block 2010 may be performed according to the methods described herein. In certain examples, aspects of the operations of block 2010 may be performed by training procedure manager 815, 915, 1050, and 1115 as described with reference to FIGS. 8 through 11.

At block 2015, the AP 105 may determine that a parameter associated with a first signal transmitted to the wake-up radio of a station at the first data rate satisfies a threshold based at least in part on the training response message. The operations of block 2015 may be performed according to the methods described herein. In certain examples, aspects of the operations of block 2015 may be performed by parameter manager 815, 915, 1020, and 1115 as described with reference to FIGS. 8 through 11.

At block 2020, the AP 105 may select a second data rate less than the first data rate based at least in part on determining that the parameter satisfies the threshold. The operations of block 2020 may be performed according to the methods described herein. In certain examples, aspects of the operations of block 2020 may be performed by data rate manager 815, 930, 1025, and 1115 as described with reference to FIGS. 8 through 11.

At block 2025, the AP 105 may transmit a second signal to the wake-up radio of the station at the second data rate. The operations of block 2025 may be performed according to the methods described herein. In certain examples, aspects of the operations of block 2025 may be performed by transmitter 820, 920, and 1135 as described with reference to FIGS. 8, 9, and 11.

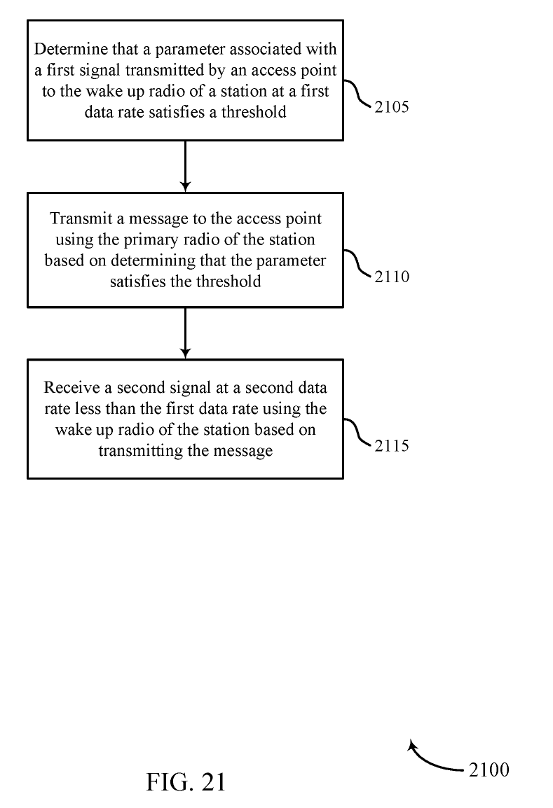

FIG. 21 shows a flowchart illustrating a method 2100 for data rate selection for wake-up radio transmissions in accordance with aspects of the present disclosure. The operations of method 2100 may be implemented by a wireless device 115 or its components as described herein. For example, the operations of method 2100 may be performed by wireless device communications manager 1215, 1315, 1415, and 1515 as described with reference to FIGS. 12 through 15. In some examples, a wireless device 115 may execute a set of codes to control the functional elements of the device to perform the functions described below. Additionally or alternatively, the wireless device 115 may perform aspects of the functions described below using special-purpose hardware.

At block 2105, the wireless device (e.g., a station) 115 may determine that a parameter associated with a first signal transmitted by an access point to the wake-up radio of the station at a first data rate satisfies a threshold. The operations of block 2105 may be performed according to the methods described herein. In certain examples, aspects of the operations of block 2105 may be performed by parameter manager 1215, 1325, 1420, and 1515 as described with reference to FIGS. 12 through 15.

At block 2110, the wireless device 115 may transmit a message to the access point using the primary radio of the station based at least in part on determining that the parameter satisfies the threshold. The operations of block 2110 may be performed according to the methods described herein. In certain examples, aspects of the operations of block 2110 may be performed by transmitter 1220, 1320, and 1535 as described with reference to FIGS. 12, 13, and 15.

At block 2115, the wireless device 115 may receive a second signal at a second data rate less than the first data rate using the wake-up radio of the station based at least in part on transmitting the message. The operations of block 2115 may be performed according to the methods described herein. In certain examples, aspects of the operations of block 2115 may be performed by receiver 1210, 1310, and 1535 as described with reference to FIGS. 12, 13, and 15.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at an access point in a system that supports communication using a primary radio and a wake-up radio, comprising:
determining that a parameter associated with a first signal transmitted to a wake-up radio of a station at a first data rate satisfies a threshold;
selecting a second data rate less than the first data rate based at least in part on determining that the parameter satisfies the threshold; and
transmitting a second signal to the wake-up radio of the station at the second data rate.

2. The method of claim 1, further comprising:
receiving an indication from the station that the station failed to decode two or more consecutive packets transmitted at the first data rate, wherein determining that the parameter satisfies the threshold is based at least in part on receiving the indication.

3. The method of claim 2, further comprising:
transmitting a beacon at the first data rate at a predetermined time based at least in part on a beacon schedule.

4. The method of claim 1, further comprising:
determining that an expected message from the station failed to be received using a primary radio of the station, wherein determining that the parameter satisfies the threshold is based at least in part on determining that the expected message failed to be received.

5. The method of claim 4, further comprising:
transmitting a traffic indication message to the wake-up radio of the station at the first data rate based at least in part on identifying buffered data for the station, wherein the expected message comprises a response to the traffic indication message.

6. The method of claim 5, wherein:
the traffic indication message comprises an indication for the station to communicate with the access point using the primary radio of the station.

7. The method of claim 1, further comprising:
identifying a distance between the access point and the station, wherein determining that the parameter satisfies the threshold is based at least in part on the distance between the access point and the station.

8. The method of claim 7, further comprising:
determining that the distance satisfies a distance threshold, wherein the second data rate is selected based at least in part on the distance threshold being satisfied.

9. The method of claim 7, further comprising:
initiating a fine timing measurement (FTM) procedure, wherein the distance is identified based at least in part on the FTM procedure.

10. The method of claim 1, further comprising:
identifying a received signal strength indicator (RSSI) associated with the station, wherein determining that the parameter satisfies the threshold is based at least in part on the RSSI.

11. The method of claim 1, further comprising:
transmitting a first training message at the first data rate to the wake-up radio of the station; and
receiving a training response message from a primary radio of the station based at least in part on the first training message, wherein determining that the parameter satisfies the threshold is based at least in part on the training response message.

12. The method of claim 11, further comprising:
transmitting a second training message at the second data rate to the wake-up radio of the station, wherein the training response message is based at least in part on the first training message and the second training message.

13. The method of claim 11, wherein:
the first training message is transmitted periodically based at least in part on a training schedule.

14. The method of claim 1, further comprising:
identifying a second parameter based on a second set of conditions different from a first set of conditions used to identify the parameter, wherein selecting the second data rate is based at least in part on the second parameter and the parameter.

15. The method of claim 1, wherein:
each of the first signal and the second signal transmitted to the wake-up radio indicates at which data rate each of the first signal and the second signal was transmitted.

16. A method for wireless communication at a station in a system that supports communication using a primary radio and a wake-up radio, comprising:
determining that a parameter associated with a first signal transmitted by an access point to the wake-up radio of the station at a first data rate satisfies a threshold;
transmitting a message to the access point using the primary radio of the station based at least in part on determining that the parameter satisfies the threshold; and
receiving a second signal at a second data rate less than the first data rate using the wake-up radio of the station based at least in part on transmitting the message.

17. The method of claim 16, further comprising:
determining that two or more consecutive packets transmitted at the first data rate to the wake-up radio of the station failed to be decoded, wherein determining that the parameter satisfies the threshold is based at least in part on failing to decode the two or more consecutive packets.

18. The method of claim 17, wherein:
the two or more consecutive packets are beacons transmitted according to a beacon schedule.

19. The method of claim 16, further comprising:
receiving a request initiating a fine timing measurement (FTM) procedure, wherein determining that the parameter satisfies the threshold is based at least in part on the FTM procedure.

20. The method of claim 16, further comprising:
receiving a first training message at the first data rate using the wake-up radio of the station; and
transmitting a training response message using a primary radio of the station based at least in part on the first training message, wherein determining that the parameter satisfies the threshold is based at least in part on the training response message.

21. The method of claim 20, further comprising:
receiving a second training message at the second data rate using the wake-up radio, wherein the training response message is based at least in part on the first training message and the second training message.

22. An apparatus for wireless communication at an access point in a system that supports communication using a primary radio and a wake-up radio, comprising:
a processor;
memory in electronic communication with the processor; and
instructions stored in the memory and operable, when executed by the processor, to cause the apparatus to:
determine that a parameter associated with a first signal transmitted to a wake-up radio of a station at a first data rate satisfies a threshold;
select a second data rate less than the first data rate based at least in part on determining that the parameter satisfies the threshold; and
transmit a second signal to the wake-up radio of the station at the second data rate.

23. The apparatus of claim 22, wherein the instructions are further executable by the processor to cause the apparatus to:
receive an indication from the station that the station failed to decode two or more consecutive packets transmitted at the first data rate; and
determine that the parameter satisfies the threshold based at least in part on receiving the indication.

24. The apparatus of claim 23, wherein the instructions are further executable by the processor to cause the apparatus to:
transmit a beacon at the first data rate at a predetermined time based at least in part on a beacon schedule.

25. The apparatus of claim 22, wherein the instructions are further executable by the processor to cause the apparatus to:
determine that an expected message from the station failed to be received using a primary radio of the station; and
determine that the parameter satisfies the threshold based at least in part on determining that the expected message failed to be received.

26. The apparatus of claim 22, wherein the instructions are further executable by the processor to cause the apparatus to:
identify a distance between the access point and the station; and
determine that the parameter satisfies the threshold based at least in part on the distance between the access point and the station.

27. The apparatus of claim 22, wherein the instructions are further executable by the processor to cause the apparatus to:
transmit a first training message at the first data rate to the wake-up radio of the station;
receive a training response message from a primary radio of the station based at least in part on the first training message; and
determine that the parameter satisfies the threshold based at least in part on the training response message.

28. An apparatus for wireless communication at a station in a system that supports communication using a primary radio and a wake-up radio, comprising:
a processor;
memory in electronic communication with the processor; and
instructions stored in the memory and operable, when executed by the processor, to cause the apparatus to:
determine that a parameter associated with a first signal transmitted by an access point to the wake-up radio of the station at a first data rate satisfies a threshold;
transmit a message to the access point using the primary radio of the station based at least in part on determining that the parameter satisfies the threshold; and
receive a second signal at a second data rate less than the first data rate using the wake-up radio of the station based at least in part on transmitting the message.

29. The apparatus of claim 28, wherein the instructions are further executable by the processor to cause the apparatus to:
determine that two or more consecutive packets transmitted at the first data rate to the wake-up radio of the station failed to be decoded; and
determine that the parameter satisfies the threshold based at least in part on failing to decode the two or more consecutive packets.

30. The apparatus of claim 28, wherein the instructions are further executable by the processor to cause the apparatus to:
receive a first training message at the first data rate using the wake-up radio of the station;
transmit a training response message using the primary radio of the station based at least in part on the first training message; and
determine that the parameter satisfies the threshold based at least in part on the training response message.
